(19) United States
(12) Patent Application Publication
(10) Pub. No.: US 2012/0128126 A1
(43) Pub. Date: May 24, 2012

(54) RADIATION PHASE IMAGE OBTAINMENT METHOD AND RADIATION PHASE IMAGE RADIOGRAPHIC APPARATUS

(75) Inventor: Hiroyasu ISHII, Ashigarakami-gun (JP)

(73) Assignee: FUJIFILM CORPORATION, Tokyo (JP)

(21) Appl. No.: 13/303,469

(22) Filed: Nov. 23, 2011

(30) Foreign Application Priority Data
Nov. 24, 2010 (JP) 2010-261072

(51) Int. Cl. G01N 23/04

(52) U.S. Cl. 378/62

(57) ABSTRACT

In a radiation phase image radiographic apparatus, a radiation image detector detects a periodic pattern image that has passed through a first grating and a second grating. The apparatus includes a magnification ratio obtainment unit that receives an input of a magnification ratio in magnification radiography to obtain the magnification ratio, a movement mechanism that moves, based on the magnification ratio, the radiation image detector relative to a subject in a direction away from the subject, a calibration data obtainment unit that obtains calibration data corresponding to the magnification ratio, and which are based on the periodic pattern image detected by the radiation image detector without placing the subject, and a phase contrast image generation unit that generates a phase contrast image based on the calibration data and the periodic pattern image detected by the radiation image detector with the subject placed.

### BACKGROUND OF THE INVENTION

1. Field of the Invention

The present invention relates to a radiation phase image obtainment method and a radiation phase image radiographic apparatus using a grating or gratings. In particular, the present invention relates to a radiation phase image obtainment method and a radiation phase image radiographic apparatus in which magnification radiography is performed.

2. Description of the Related Art

Since X-rays attenuate depending on the atomic number of an element constituting a substance through which the X-rays pass, and the density and the thickness of the substance, the X-rays are used as a probe for observing the inside of a subject from the outside of the subject. Radiography using X-rays is widely used in medical diagnosis, non-destructive examination, and the like.

In a general X-ray radiography system, a subject is placed between an X-ray source for outputting X-rays and an X-ray image detector for detecting an X-ray image. In this state, radiography is performed on the subject to obtain a transmission image of the subject. In this case, each of the X-rays output from the X-ray source toward the X-ray image detector attenuates (is absorbed) by an amount based on a difference in the properties (atomic number, density, and thickness) of a substance or substances constituting the subject that is present in a path to the X-ray image detector, and the attenuated X-rays enter the X-ray image detector. Consequently, an X-ray transmission image of the subject is detected by the X-ray image detector, and an image is formed. As the X-ray image detector, a combination of an X-ray sensitizing screen and a film, or a photostimulable phosphor (storage phosphor) are used. Further, a flat panel detector (FPD) using a semiconductor circuit is widely used.

However, the X-ray absorptivity of a substance is lower as the atomic number of an element constituting the substance is smaller. Since a difference in X-ray absorptivity is small in soft tissue of a living body, soft material, and the like, a sufficient difference in intensity (contrast) as an X-ray transmission image is not obtainable. For example, both of cartilage constituting a joint in a human body and synovial fluid around the joint are mostly composed of water. Therefore, a difference in X-ray absorptivity between the two is small, and a sufficient contrast in an image is hard to obtain.

In recent years, X-ray phase imaging has been studied. In X-ray phase imaging, a phase contrast image based on a shift in the phase of X-rays caused by a difference in the refractive index of a subject to be examined is obtained, instead of an image based on a change in the intensity of X-rays caused by a difference in the absorption coefficient of the subject. In the X-ray phase imaging using the phase difference, high contrast images are obtainable even if the subject is a low absorption object, which has low X-ray absorptivity.

In X-ray phase imaging, for example, an X-ray phase image radiographic apparatus has been proposed. In the X-ray phase image radiographic apparatus, two gratings, namely, a first grating and a second grating are arranged parallel to each other with a predetermined distance therebetween. Further, a self image of the first grating is formed at the position of the second grating by a Talbot interference effect by the first grating. Further, the second grating modulates the intensity of the self image to obtain an X-ray phase contrast image.

Meanwhile, conventionally, so-called magnification radiography was proposed. In magnification radiography, a radiographic image of a subject is magnified by controlling a distance between the subject and a radiation image detector, and the magnified image is projected onto the radiation image detector. For example, PCT International Publication No. WO2008-102598 (Patent Document 1) proposes magnification radiography by a radiographic apparatus in which a Talbot interferometer method, a Talbot-Lau interferometer method, and a refraction contrast method are switchable. In the radiographic apparatus, magnification radiography is performed at various magnification ratios by vertically moving a table on which the subject is placed.

In the aforementioned X-ray phase image radiographic apparatus, when the distribution of doses of radiation output from the radiation source is corrected at the radiation image detector, or a phase contrast image is generated, an operation processing is performed by using calibration data obtained by performing radiography without placing the subject.

However, for example, in correction of the distribution of doses of radiation, appropriate correction is not possible if the same correction data are used for magnification radiography at various magnification ratios, because the distribution of doses of radiation differs depending on the magnification ratios.

Further, the position of the radiation image detector is changed based on the magnification ratio of magnification radiography. Therefore, a range of a grating detected by each pixel of the radiation image detector also changes, and phase offset and phase sensitivity of each pixel fluctuate.

Therefore, if the same calibration data are uniformly used to generate phase contrast images, it is impossible to generate an appropriate phase contrast image at some magnification ratio.

However, Patent Document 1 is silent about the aforementioned problems, and fails to propose any solution for solving the problems.

### SUMMARY OF THE INVENTION

In view of the foregoing circumstances, it is an object of the present invention to provide a radiation phase image obtainment method in which calibration appropriate for magnification radiography at each magnification ratio is possible in a radiation phase image radiographic apparatus that performs magnification radiography at various magnification ratios. Further, it is another object of the present invention to provide the radiation phase image radiographic apparatus.

A radiation phase image obtainment method of the present invention is a radiation phase image obtainment method for obtaining a phase contrast image of a subject by using a radiation phase image radiographic apparatus,

wherein the radiation phase image radiographic apparatus includes a first grating in which a grating structure is periodically arranged, and that forms a first periodic pattern image by passing radiation output from a radiation source, and a second grating in which a grating structure having a part that transmits the first periodic pattern image farmed by the first grating and a part that blocks the first periodic pattern image is periodically arranged, and that forms a second periodic pattern image, and a radiation image detector that detects the second periodic pattern image formed by the second grating, and

wherein the radiation phase image radiographic apparatus performs magnification radiography by moving the radiation image detector relative to a subject in a direction away from the subject,

the method comprising the steps of:

receiving an input of a magnification ratio in the magnification radiography;

obtaining calibration data corresponding to the received magnification ratio, and which are based on the second periodic pattern image detected by the radiation image detector without placing the subject; and

obtaining the phase contrast image based on the obtained calibration data and the second periodic pattern image detected by the radiation image detector with the subject placed.

A radiation phase image radiographic apparatus of the present invention is a radiation phase image radiographic apparatus comprising:

a first grating in which a grating structure is periodically arranged, and that forms a first periodic pattern image by passing radiation output from a radiation source;

a second grating in which a grating structure having a part that transmits the first periodic pattern image formed by the first grating and a part that blocks the first periodic pattern image is periodically arranged, and that forms a second periodic pattern image;

a radiation image detector that detects the second periodic pattern image formed by the second grating;

a magnification ratio obtainment unit that receives an input of a magnification ratio in magnification radiography to obtain the magnification ratio;

a movement mechanism that moves, based on the magnification ratio obtained by the magnification ratio obtainment unit, the radiation image detector relative to a subject in a direction away from the subject;

a calibration data obtainment unit that obtains calibration data corresponding to the magnification ratio obtained by the magnification ratio obtainment unit, and which are based on the second periodic pattern image detected by the radiation image detector without placing the subject; and

a phase contrast image generation unit that generates a phase contrast image based on the calibration data obtained by the calibration data obtainment unit and the second periodic pattern image detected by the radiation image detector with the subject placed.

In a radiation phase image radiographic apparatus of the present invention, calibration data corresponding to a plurality of magnification ratios may be set in advance in the calibration data obtainment unit.

The calibration data obtainment unit may obtain the calibration data corresponding to the magnification ratio after the movement mechanism has moved the radiation image detector by a distance corresponding to the magnification ratio.

A displacement detection unit that detects a displacement (shift) in the position of the first grating or the second grating may be further provided. Further, the calibration data obtainment unit may obtain the calibration data when the displacement detection unit has detected a displacement in the position of the first grating or the second grating.

Calibration data may have been corrected by using sensitivity correction data about the radiation image detector corresponding to the magnification ratio obtained by the magnification ratio obtainment unit.

Alternatively, calibration data may have been corrected by using offset correction data about the radiation image detector.

A scan mechanism that moves at least one of the first grating and the second grating in a direction orthogonal to a direction in which the at least one of the first grating and the second grating extends may be provided. Further, the phase contrast image generation unit may generate the phase contrast image based on a plurality of second periodic pattern images detected by the radiation image detector with respect to respective positions of the at least one of the first grating and the second grating with movement by the scan mechanism.

The first grating and the second grating may be arranged in such a manner that a direction in which the first grating extends and a direction in which the second grating extends incline relative to each other. Further, the phase contrast image generation unit may generate the phase contrast image by using radiographic image signals detected by the radiation image detector by irradiating the subject with the radiation only once.

Further, the phase contrast image generation unit may obtain, based on the radiographic image signals detected by the radiation image detector, radiographic image signals read out from groups of pixel rows, and the groups being different from each other, as radiographic image signals representing a plurality of fringe images different from each other, and generate the phase contrast image based on the obtained radiographic image signals representing the plurality of fringe images.

According to the radiation phase image obtainment method and the radiation phase image radiographic apparatus of the present invention, an input of a magnification ratio in magnification radiography is received, and calibration data corresponding to the received magnification ratio, and which are based on a second periodic pattern image detected by a radiation image detector without placing a subject are obtained. Further, a phase contrast image is obtained based on the obtained calibration data and the second periodic pattern image detected by the radiation image detector with the subject placed. Therefore, even if the distribution of doses of radiation at the radiation image detector, a phase offset, and a phase sensitivity change by magnification radiography, appropriate calibration for each magnification radiography is possible. Hence, it is possible to obtain appropriate phase contrast images.

### BRIEF DESCRIPTION OF THE DRAWINGS

FIG. 1 is a schematic diagram illustrating the configuration of a mammography and display system using an embodiment of a radiation phase image radiographic apparatus of the present invention;

FIG. 2 is a schematic diagram illustrating a radiation source, first and second gratings, and a radiation image detector extracted from a mammography apparatus illustrated in FIG. 1;

FIG. 3 is a top view of the radiation source, the first and second gratings and the radiation image detector illustrated in FIG. 2;

FIG. 4 is a schematic diagram illustrating the structure of the first grating;

FIG. 5 is a schematic diagram illustrating the structure of the second grating;

FIG. 6 is a block diagram illustrating the internal structure of a computer in the mammography and display system illustrated in FIG. 1;

FIG. 7 is an example of a correspondence table between magnification ratios and calibration data for the respective magnification ratios;

FIG. 8 is a schematic diagram illustrating an example of offset correction data of the radiation image detector;

FIG. 9 is a schematic diagram illustrating an example of sensitivity correction data of the radiation image detector;

FIG. 10 is a diagram illustrating relationships among image Dx for sensitivity correction, fringe image data Dg for calibration before performing sensitivity correction, and calibration data Dp after performing sensitivity correction;

FIG. 11 is a schematic diagram illustrating an example of calibration data Dp (k=0 through M−1) obtained by performing offset correction and sensitivity correction on fringe images for calibration obtained by radiography at respective positions of the second grating;

FIG. 12 is a flow chart for explaining the action of the mammography and display system using an embodiment of the radiation phase image radiographic apparatus of the present invention;

FIG. 13 is a diagram illustrating an example of a path of a radiation ray refracted based on phase shift distribution Φ(x) related to X direction of a subject to be examined;

FIG. 14 is a diagram for explaining translational motion of the second grating;

FIG. 15 is a diagram for explaining a method for generating a phase contrast image;

FIG. 16 is a schematic diagram illustrating the configuration of a mammography and display system using another embodiment of the radiation phase image radiographic apparatus of the present invention;

FIG. 17 is a diagram illustrating arrangement relationships among the first grating, the second grating and pixels on the radiation image detector when plural fringe images are obtained by performing one radiography operation;

FIG. 18 is a diagram for explaining a method for setting an inclination angle of the first grating with respect to the second grating;

FIG. 19 is a diagram for explaining a method for adjusting the inclination angle of the first grating with respect to the second grating;

FIG. 20 is a diagram for explaining an action for obtaining plural fringe images based on image signals read out from the radiation image detector;

FIG. 21 is a diagram for explaining an action for obtaining plural fringe images based on image signals read out from the radiation image detector;

FIG. 22A is a diagram illustrating an example of a radiation image detector having a function of the second grating;

FIG. 22B is a diagram illustrating an example of a radiation image detector having a function of the second grating;

FIG. 22C is a diagram illustrating an example of a radiation image detector having a function of the second grating;

FIG. 23A is a diagram for explaining an action for recording a radiographic image at the radiation image detector illustrated in FIGS. 22A through 22C:

FIG. 23B is a diagram for explaining an action for recording a radiographic image at the radiation image detector illustrated in FIGS. 22A through 22C:

FIG. 24 is a diagram for explaining an action for reading out a radiographic image at the radiation image detector illustrated in FIGS. 22A through 22C;

FIG. 25 is a diagram illustrating another example of the radiation image detector having a function of the second grating;

FIG. 26A is a diagram for explaining an action for recording a radiographic image at the radiation image detector illustrated in FIG. 25;

FIG. 26B is a diagram for explaining an action for recording a radiographic image at the radiation image detector illustrated in FIG. 25;

FIG. 27 is a diagram for explaining an action for reading out a radiographic image at the radiation image detector illustrated in FIG. 25;

FIG. 28 is a diagram illustrating another shape of a charge storage layer in the radiation image detector illustrated in FIGS. 22A through 22C;

FIG. 29 is a diagram for explaining a method for generating an absorption image and a small-angle scattering image;

FIG. 30A is a diagram for explaining a structure in which the first grating and the second grating are rotated by 90°; and

FIG. 30B is a diagram for explaining a structure in which the first grating and the second grating are rotated by 90°.

### DESCRIPTION OF THE PREFERRED EMBODIMENTS

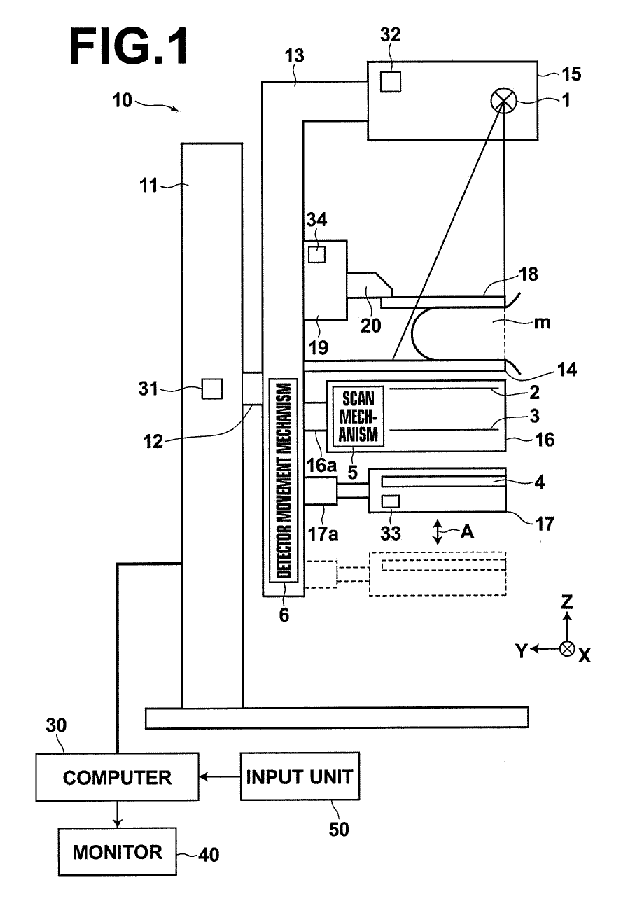

Hereinafter, a mammography and display system using an embodiment of a radiation phase image radiographic apparatus according to the present invention will be described with reference to drawings. FIG. 1 is a schematic diagram illustrating the configuration of the whole mammography and display system using an embodiment of the present invention.

As illustrated in FIG. 1, the mammography and display system of the present invention includes a mammography apparatus 10, a computer 30 connected to the mammography apparatus 10, a monitor 40 connected to the computer 30, and an input unit 50.

As illustrated in FIG. 1, the mammography apparatus 10 includes a base 11, a rotation shaft 12, and an arm 13. The rotation shaft 12 is movable in a vertical direction (Z direction) with respect to the base 11, and rotatable. The arm 13 is connected to the base 11 by the rotation shaft 12.

The arm 13 is alphabet “C” shaped. A radiography table 14 on which breast m is to be set is provided on one side of the arm 13, and a radiation source unit 15 is provided on the other side of the arm 13 in such a manner to face the radiography table 14. The vertical movement of the arm 13 is controlled by an arm controller 31, which is integrated into the base 11.

Further, a grid unit 16 and a detector unit 17 are arranged, in this order from the radiography table 14 side, on one side of the radiography table 14 opposite to a breast setting surface of the radiography table 14.

The grid unit 16 is connected to the arm 13 through a grid support unit 16a. Further, a first grating 2, a second grating 3, and a scan mechanism 5, which will be described later in detail, are provided in the grid unit 16.

The detector unit 17 is connected to the arm 13 through a cassette support unit 17a. The cassette support unit 17a supports the detector unit 17, and the detector unit 17 is detachable from the cassette support unit 17a. Further, a detector movement mechanism 6 that moves the cassette support unit 17a in a vertical direction (Z direction) is provided in the arm 13. The detector movement mechanism 6 moves the detector unit 17 by a distance corresponding to a magnification ratio in magnification radiography. The detector movement mechanism 6 is controlled by the arm controller 31. The method for controlling the detector movement mechanism 6 will be described later in detail. In the present embodiment, the magnification ratio is represented by b/a when a distance from the focal point of the radiation source 1 to breast m is “a”, and a distance from the focal point of the radiation source 1 to a detection surface of a radiation image detector 4 is “b”.

Further, the radiation image detector 4, such as a flat panel detector, and a detector controller 33 are provided in the detector unit 17. The detector controller 33 controls readout of charge signals from the radiation image detector 4, and the like. Further, although illustration is omitted, a circuit substrate on which a charge amplifier, a correlated double sampling circuit, an AD converter or the like is set is provided in the detector unit 17. The charge amplifier converts charge signals read out from the radiation image detector 4 to voltage signals. The correlated double sampling circuit performs sampling on the voltage signals output from the charge amplifier. The AD converter converts the voltage signals to digital signals.

The radiation image detector 4 can repeat recording and readout of radiographic images. As the radiation image detector 4, a so-called direct-type radiation image detector may be used. The direct-type radiation image detector generates charges by direct irradiation with radiation. Alternatively, a so-called indirect-type radiation image detector may be used. The indirect-type radiation image detector temporarily converts radiation to optical photon, and converts the optical photon to charge signals. As a method for reading out radiographic image signals, it is desirable to use a so-called TFT readout method or a so-called optical readout method. In the TFT readout method, radiographic image signals are readout by turning a TFT (thin film transistor) switch on or off. In the optical readout method, radiographic image signals are read out by illumination with readout light. However, the method for reading out radiographic image signals is not limited to these methods, and a different method may be used.

The radiation source 1 and a radiation source controller 32 are housed in the radiation source unit 15. The radiation source controller 32 controls timing of outputting radiation from the radiation source 1 and radiation generation conditions (tube current, time, tube voltage, and the like) at the radiation source 1.

Further, a compression plate 18, a compression plate support unit 20, and a compression plate movement mechanism 19 are provided at a central part of the arm 13. The compression plate 18 is arranged on the upper side of the radiography table 14, and the compression plate 18 compresses a breast by pressing the breast onto the radiography table 14. The compression plate support unit 20 supports the compression plate 18, and the compression plate movement mechanism 19 moves the compression plate support unit 20 in a vertical direction (Z direction). The position of the compression plate 18 and a pressure applied during compression are controlled by the compression plate controller 34.

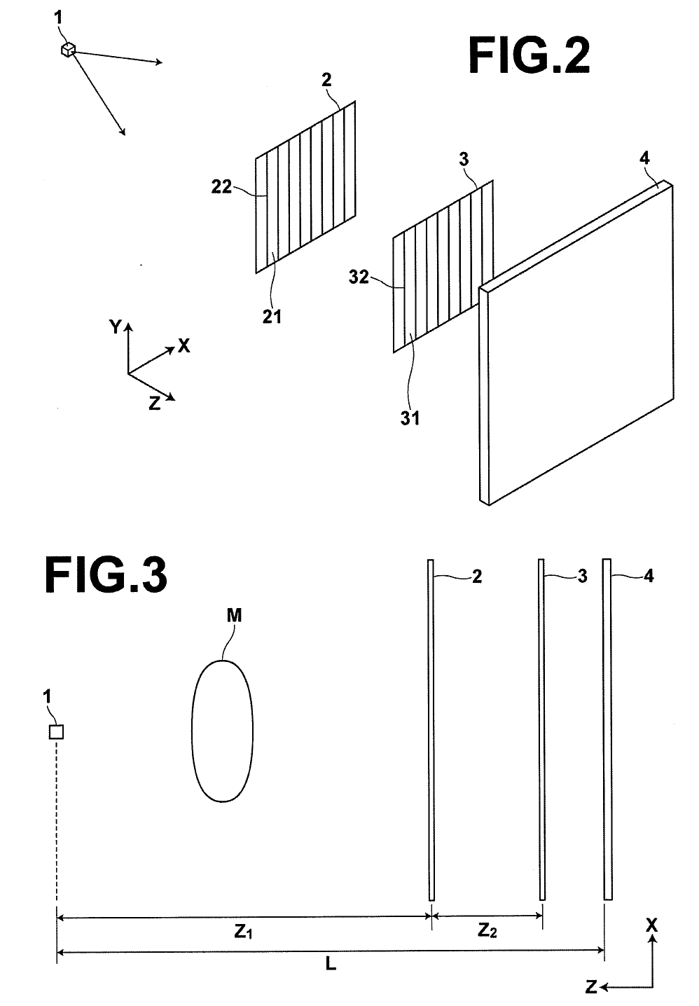

Here, the mammography and display system in the present embodiment performs radiography to obtain a phase contrast image of breast m by using the radiation source 1, the first grating 2, the second grating 3 and the radiation image detector 4. The structure of the radiation source 1, the first grating 2 and the second grating 3 necessary to perform radiography for obtaining the phase contrast image will be described more in detail. FIG. 2 is a diagram in which only the radiation source 1, the first grating 2, the second grating 3 and the radiation image detector 4 are extracted from FIG. 1. FIG. 3 is a schematic top view of the radiation source 1, the first grating 2, the second grating 3 and the radiation image detector 4 illustrated in FIG. 2.

The radiation source 1 outputs radiation toward breast m. The radiation source 1 has sufficient spatial coherence to produce a Talbot interference effect when the first grating 2 is irradiated with radiation. For example, a radiation source, such as a microfocus X-ray tube and a plasma X-ray source, which has a small-size radiation output point may be used as the radiation source 1. When a radiation source having a relatively large-size radiation output point (so-called focal point size), as used in ordinary medical treatment, is used, the radiation source may be used by setting a multi-slit having a predetermined pitch on the radiation output side of the radiation source. A detail structure of such a case is disclosed, for example, in “Franz Pfeiffer, Timm Weikamp, Oliver Bunk, Christian David, Nature Physics 2, 258-261 (1 Apr. 2006) Letters, Phase retrieval and differential phase-contrast imaging with low-brilliance X-ray sources”. It is necessary that pitch P₀ of the slit satisfies the following formula (1):

### [FORMULA 1]

P₀=P₂×Z₁/Z₂ (1)

In the formula (1), P₂ is the pitch of the second grating 3. As illustrated in FIG. 3, Z₁ is a distance from the focal point of the radiation source 1 (the position of a multi-slit when the multi-slit is used) to the first grating 2. Further, Z₂ is a distance from the first grating 2 to the second grating 3.

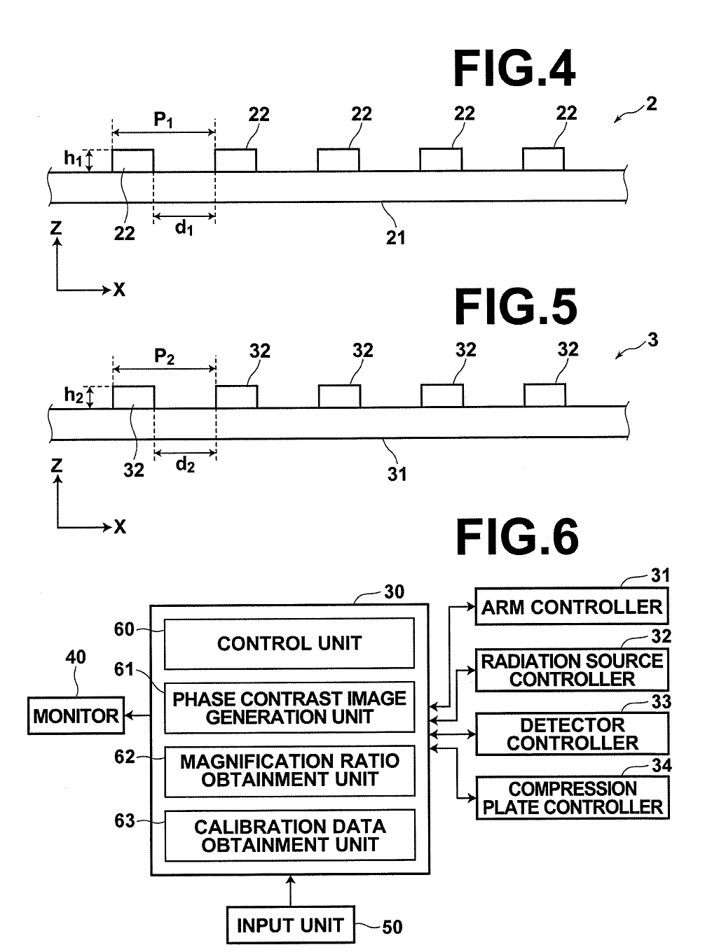

The first grating 2 passes radiation that has been output from the radiation source 1, and forms a first periodic pattern image. As illustrated in FIG. 4, the first grating 2 includes a substrate 21 that mostly passes radiation and plural members 22 provided on the substrate 21. Each of the plural members 22 is a linear member extending in an in-plane direction (Y direction orthogonal to both X direction and Z direction, and which is the direction of the paper thickness in FIG. 4) orthogonal to the optical axis of radiation. The plural members 22 are arranged at constant cycle P₁ with predetermined interval d₁ therebetween in X direction. As the material of the members 22, metal, such as gold and platinum, may be used, for example. Further, it is desirable that the first grating 2 is a so-called phase-modulation-type grating that modulates the phase of radiation irradiating the first grating 2 by approximately 90° or by approximately 180°. For example, when the members 22 are made of gold, thickness h₁ of the member 22 required in an X-ray energy range for ordinary medical diagnosis is approximately in the range of 1 μm to a few μm. Alternatively, an amplitude-modulation-type grating may be used. In this case, it is necessary that the member 22 has a sufficient thickness to absorb radiation. For example, when the members 22 are made of gold, thickness h₁ of the member 22 required in an X-ray energy range for ordinary medical diagnosis is approximately in the range of 10 μm to tens of μm.

The second grating 3 modulates the intensity of the first periodic pattern image formed by the first grating 2, and forms a second periodic pattern image. As illustrated in FIG. 5, the second grating 3 includes a substrate 31 that mostly passes radiation and plural members 32 provided on the substrate 31 in a manner similar to the first grating 2. The plural members 32 block radiation, and each of the plural members 32 is a linear member extending in an in-plane direction (Y direction orthogonal to both X direction and Z direction, and which is the direction of the paper thickness in FIG. 5) orthogonal to the optical axis of radiation. The plural members 32 are arranged at constant cycle P₂ with predetermined interval d₂ therebetween in X direction. As the material of the members 32, metal, such as gold and platinum, may be used, for example. It is desirable that the second grating 3 is an amplitude-modulation-type grating. In such a case, it is necessary that the member 32 has a sufficient thickness to absorb radiation. For example, when the members 32 are made of gold, thickness h₂ required in an X-ray energy range for ordinary medical diagnosis is approximately in the range of 10 μm to tens of μm.

Here, when radiation output from the radiation source 1 is not a parallel beam but a cone beam, a self image of the first grating 2 formed through the first grating 2 is magnified in proportion to a distance from the radiation source 1. Further, in the present embodiment, grating pitch P₂ and interval d₂ of the second grating 3 are determined in such a manner that slit portions of the second grating 3 substantially coincide with a periodic pattern of light portions of the self image of the first grating 2 at the position of the second grating 3. Specifically, when a distance from the focal point of the radiation source 1 to the first grating 2 is Z₁, and a distance from the first grating 2 to the second grating 3 is Z₂, grating pitch P₂ and interval d₂ of the second grating 3 are determined so as to satisfy the following formulas (2) and (3):

$$\begin{matrix}[ FORMULA 2 ] & \\ {P}_{2} = \frac{{Z}_{1} + {Z}_{2}}{{Z}_{1}} {P}_{1} & ( 2 ) \\ [ FORMULA 3 ] & \\ {d}_{2} = \frac{{Z}_{1} + {Z}_{2}}{{Z}_{1}} {d}_{1} . & ( 3 )\end{matrix}$$

When radiation output from the radiation source 1 is a parallel beam, the pitch P₂ and the interval d₂ of the second grating 3 are determined so as to satisfy P₂=P₁, and d₂=d₁.

Further, it is necessary that some other conditions are substantially satisfied to make the mammography apparatus 10 in the present embodiment function as a Talbot interferometer. Such conditions will be described.

First, it is necessary that the grid plane of the first grating 2 and the grid plane of the second grating 3 are parallel to X-Y plane illustrated in FIG. 2.

Further, when the first grating 2 is a phase-modulation-type grating that modulates phase by 90°, distance Z₂ between the first grating 2 and the second grating 3 must substantially satisfy the following condition:

$$\begin{matrix}[ FORMULA 4 ] & \\ {Z}_{2} = ( m + \frac{1}{2} ) \frac{{P}_{1} {P}_{2}}{λ} , & ( 4 )\end{matrix}$$

where λ is the wavelength of radiation (ordinarily, a peak wavelength), m is 0 or a positive integer, P₁ is a grating pitch of the first grating 2, as described above, and P₂ is a grating pitch of the second grating 3, as described above.

Further, when the first grating 2 is a phase-modulation-type grating that modulates phase by 180°, the following condition must be substantially satisfied:

$$\begin{matrix}[ FORMULA 5 ] & \\ {Z}_{2} = ( m + \frac{1}{2} ) \frac{{P}_{1} {P}_{2}}{2 λ} , & ( 5 )\end{matrix}$$

where λ is the wavelength of radiation (ordinarily, a peak wavelength), m is 0 or a positive integer, P₁ is a grating pitch of the first grating 2, as described above, and P₂ is a grating pitch of the second grating 3, as described above.

Alternatively, when the first grating 2 is an amplitude-modulation-type grating, the following condition must be substantially satisfied:

$$\begin{matrix}[ FORMULA 6 ] & \\ {Z}_{2} = m \frac{{P}_{1} {P}_{2}}{λ} , & ( 6 )\end{matrix}$$

where λ is the wavelength of radiation (ordinarily, a peak wavelength), m is a positive integer, P₁ is a grating pitch of the first grating 2, as described above, and P₂ is a grating pitch of the second grating 3, as described above.

The formulas (4), (5) and (6) are used when radiation output from the radiation source 1 is a cone beam. When the radiation output from the radiation source 1 is a parallel beam, the following formula (7) is used instead of the formula (4), and the following formula (8) is used instead of the formula (5), and the following formula (9) is used instead of the formula (6):

$$\begin{matrix}[ FORMULA 7 ] & \\ {Z}_{2} = ( m + \frac{1}{2} ) \frac{{P}_{1}^{2}}{λ} & ( 7 ) \\ [ FORMULA 8 ] & \\ {Z}_{2} = ( m + \frac{1}{2} ) \frac{{P}_{1}^{2}}{4 λ} & ( 8 ) \\ [ FORMULA 9 ] & \\ {Z}_{2} = m \frac{{P}_{1}^{2}}{λ} . & ( 9 )\end{matrix}$$

As illustrated in FIGS. 4 and 5, the thickness of the members 22 of the first grating is h₁, and the thickness of the members 32 of the second grating is h₂. When the thickness h₁ and the thickness h₂ are too thick, radiation that diagonally enters the first grating 2 and the second grating 3 tends not to pass through slit portions, and so-called vignetting occurs. Consequently, an effective field of view in a direction (X direction) orthogonal to the direction in which the members 22, 32 extend becomes narrow. Therefore, it is necessary to regulate the upper limits of the thicknesses h₁, h₂ to maintain a sufficient field of view. It is necessary that the thicknesses h₁, h₂ are set so as to satisfy the formulas (10) and (11) to maintain length V of the effective field of view in X direction on the detection surface of the radiation image detector 4. Here, L is a distance from the focal point of the radiation source 1 to the detection surface of the radiation image detector 4 (please refer to FIG. 3):

$$\begin{matrix}[ FORMULA 10 ] & \\ {h}_{1} \leq \frac{L}{V / 2} {d}_{1} & ( 10 ) \\ [ FORMULA 11 ] & \\ {h}_{2} \leq \frac{L}{V / 2} {d}_{2} . & ( 11 )\end{matrix}$$

Further, the scan mechanism 5 provided in the grid unit 16 translationally moves the second grating 3, as described above, in a direction (X direction) orthogonal to the extending direction of the members 32, in other words, the second grating 3 is moved in parallel. Accordingly, relative positions between the first grating 2 and the second grating 3 are changed. For example, the scan mechanism 5 is composed of an actuator, such as a piezoelectric element. Further, a second periodic pattern image formed by the second grating 3 at each position of the second grating 3 that is translationally moved by the scan mechanism 5 is detected by the radiation image detector 4.

FIG. 6 is a block diagram illustrating the configuration of the computer 30 illustrated in FIG. 1. The computer 30 includes a central processing unit (CPU), a storage device, such as a semiconductor memory, a hard disk and an SSD (solid-state drive or disk), and the like. Such hardware constitutes a control unit 60, a phase contrast image generation unit 61, a magnification ratio obtainment unit 62, and a calibration data obtainment unit 63, as illustrated in FIG. 6.

The control unit 60 outputs predetermined control signals to various controllers 31 through 34 to control the whole system. Further, the control unit 60 controls the detector movement mechanism 6, illustrated in FIG. 1, based on the magnification ratio of magnification radiography input at the input unit 50. A specific control method by the control unit 60 will be described later.

The phase contrast image generation unit 61 generates a radiation phase contrast image based on image signals representing plural kinds of fringe images that are different from each other, and which have been detected by the radiation image detector 4 with respect to respective positions of the second grating 3. The method for generating the radiation phase contrast image will be described later.

The magnification ratio obtainment unit 62 obtains the magnification ratio of magnification radiography that has been input at the input unit 50, and outputs the magnification ratio to the calibration data obtainment unit 63.

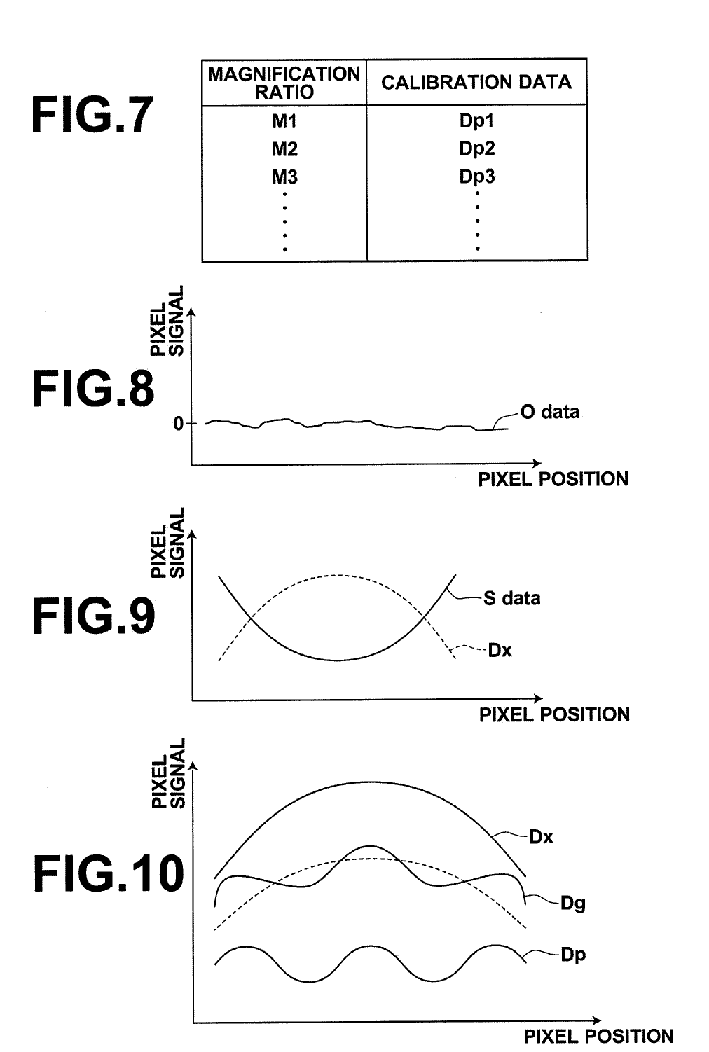

The calibration data obtainment unit 63 obtains calibration data corresponding to the magnification ratio obtained by the magnification ratio obtainment unit 62. Specifically, as illustrated in FIG. 7, the calibration data obtainment unit 63 stores plural magnification ratios M1, M2, M3, . . . and calibration data D1, D2, D3, which have been obtained in advance by performing magnification radiography at the plural magnification ratios, in such a manner to be correlated with each other. The calibration data obtainment unit 63 obtains calibration data corresponding to an input magnification ratio, and outputs the calibration data to the phase contrast image generation unit 61.

Next, calibration data in the present embodiment will be described. The calibration data in the present embodiment are used to correct phase offset and phase sensitivity when a phase contrast image is generated by the phase contrast image generation unit 61. The calibration data are obtained by detecting, with respect to each position of the second grating 3, radiation that has passed through the first grating 2 and the second grating 3 without placing subject m by the radiation image detector 4.

Specifically, in a manner similar to radiography for obtaining a phase contrast image, which will be described alter, the second grating 3 is translationally moved with respect to the first grating 2 in X direction (a direction orthogonal to a direction in which the members 32 of the second grating 3 extend), step by step, by a distance of 1/(the integer of arrangement pitch P₂ of the second grating 3). Further, a fringe image for calibration formed by the first grating 2 and the second grating 3 for each position of the second grating 3 is radiographed by being detected by the radiation image detector 4.

In the present embodiment, offset correction and sensitivity correction of the radiation image detector 4 are performed on the plural fringe images for calibration, which have been obtained by radiography as described above, and data after correction are obtained as the calibration data.

Offset correction data Odata of the radiation image detector 4 are generated based on an image for offset correction that has been output from the radiation image detector 4 in a state without outputting radiation to the radiation image detector 4. FIG. 8 is a schematic diagram illustrating an example of offset correction data Odata. It is desirable that the offset correction data Odata are obtained by averaging, for each pixel, plural images for offset correction to reduce random noise.

Further, sensitivity correction data Sdata of the radiation image detector 4 are generated based on image Dx for sensitivity correction that has been output from the radiation image detector 4 by irradiating the radiation image detector 4 with uniform radiation that has passed none of the subject, the first grating 2 and the second grating 3. The sensitivity correction data Sdata are generated based on data obtained by performing offset processing on the image Dx for sensitivity correction by using the offset correction data Odata. Specifically, the sensitivity correction data Sdata are obtained by using the following formula:

Sdata=C/average[Dx−Odata],

where C is a normalization coefficient.

It is desirable that the sensitivity correction data Sdata are obtained by averaging, for each pixel, plural images Dx for sensitivity correction, on which offset correction has been performed as in the above formula, to reduce random noise. FIG. 9 is a schematic diagram illustrating an example of sensitivity correction data Sdata generated based on the image Dx for sensitivity correction.

Further, an operation by using the following formula is performed. Consequently, calibration data Dp (k=0 through M−1), on which offset correction and sensitivity correction of the radiation image detector 4 have been performed on fringe image data Dg for calibration, are obtained:

Dp(k=0 through M−1)=(Dg(k=0 through M−1)−Odata)×Sdata.

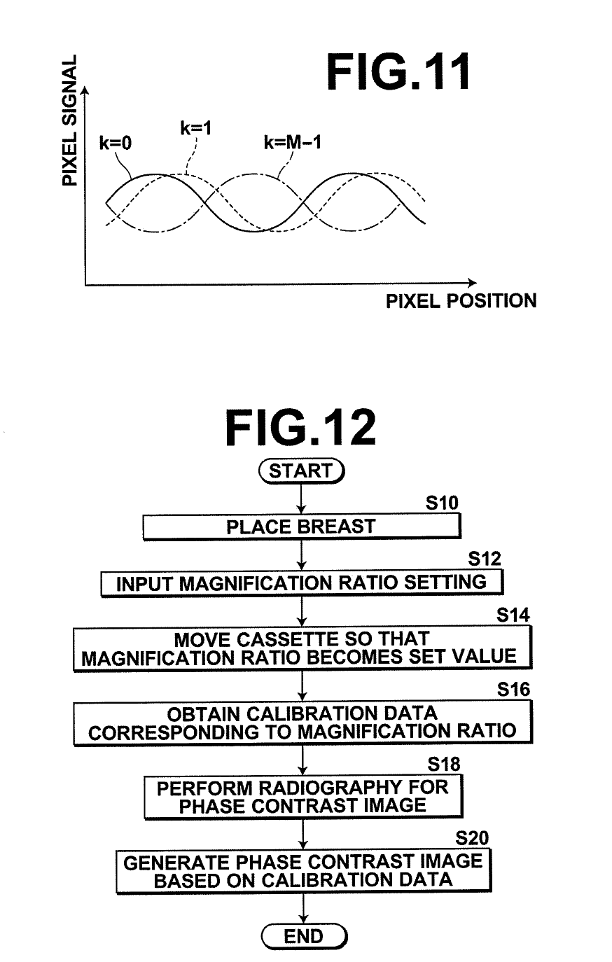

FIG. 10 is a diagram illustrating relationships among image Dx for sensitivity correction, fringe image data Dg for calibration before performing sensitivity correction, and calibration data Dp, which have been described. FIG. 11 is a schematic diagram illustrating an example of calibration data Dp(k=0 through M−1) obtained by performing offset correction and sensitivity correction on fringe images for calibration obtained by radiography with respect to positions k=0 through M−1 of the second grating 3.

The calibration data Dp as described above are obtained by performing radiography at each position of the radiation image detector 4 corresponding to each magnification ratio. The calibration data Dp are stored in advance in the calibration data obtainment unit 63 in such a manner to be correlated with the magnification ratios. Specifically, calibration data Dp representing M calibration images (M is the number of images) are stored for each magnification ratio. Since the sensitivity correction data Sdata used to obtain the calibration data Dp differ depending on the magnification ratio, the sensitivity correction data Sdata are also obtained for each magnification ratio.

The monitor 40 displays a phase contrast image generated by the phase contrast image generation unit 61 in the computer 30.

For example, the input unit 50 is composed of a keyboard and a pointing device, such as a mouse. The input unit 50 receives an input of a radiography condition, an instruction to start radiography, and the like by a radiographer (a user who performs radiography). Especially, in the present embodiment, an input of a magnification ratio in magnification radiography is received at the input unit 50.

Next, the action of the mammography and display system in the present embodiment will be described with reference to a flow chart illustrated in FIG. 12.

First, breast m of a patient is placed on the radiography table 14, and the breast m is compressed by the compression plate 18 at a predetermined pressure (step S10).

Then, the radiographer inputs a magnification ratio of magnification radiography by using the input unit 50 (step S12). The magnification ratio received at the input unit 50 is obtained by the magnification ratio obtainment unit 62, and output to the control unit 60.

The control unit 60 outputs a control signal to the arm controller 31 so that magnification radiography at the input magnification ratio is performed. The arm controller 31 drives and controls the detector movement mechanism 6 based on the control signal. Further, the detector movement mechanism 6 moves the detector unit 17 in a vertical direction (step S14). Specifically, the detector movement mechanism 6 moves the detector unit 17 in Z direction so that a distance between the radiation source 1 and the detection surface of the radiation image detector 4 becomes a distance corresponding to the magnification ratio that has been set and input by the radiographer.

Meanwhile, the magnification ratio obtained by the magnification ratio obtainment unit 62 is also output to the calibration data obtainment unit 63. The calibration data obtainment unit 63 reads out calibration data Dp (k=0 through M−1) corresponding to the input magnification ratio, and outputs the calibration data Dp (k=0 through M−1) to the phase contrast image generation unit 61 (step S16).

After the detector unit 17 is placed at a position corresponding to the magnification ratio, as described above, radiography is performed to obtain a phase contrast image (step S18).

Specifically, first, radiation is output from the radiation source 1 based on an input of an instruction for starting radiography by the radiographer. After the radiation passes through breast m, the radiation irradiates the first grating 2. The radiation that has irradiated the first grating 2 is diffracted by the first grating 2. Accordingly, a Talbot interference image is formed at a position away from the first grating 2 by a predetermined distance in the optical axis direction of radiation.

This effect is called as a Talbot effect. When a light wave passes through the first grating 2, a self image of the first grating 2 is formed at a position away from the first grating 2 by a predetermined distance. For example, when the first grating 2 is a phase-modulation-type grating that modulates phase by 90°, a self image of the first grating 2 is formed at a distance given by the formula (4) or (7) (when a phase-modulation-type grating that modulates phase by 180° is used, a distance given by the formula (5) or (8), and when an intensity-modulation-type grating is used, a distance given by the formula (6) or (9)). Since the wavefront of radiation entering the first grating 2 is distorted by the breast m, which is a subject to be examined, the self image of the first grating 2 is deformed based on the distortion.

Then, the radiation passes through the second grating 3. Consequently, the deformed self image of the first grating 2 is superimposed on the second grating 3, and the intensity of the deformed self image is modulated. The deformed self image is detected by the radiation image detector 4, as image signals reflecting the distortion of the wavefront. The image signals detected by the radiation image detector 4 are input to the phase contrast image generation unit 61 in the computer 30.

Further, the phase contrast image generation unit 61 performs offset correction and sensitivity correction on the input image signals by using the aforementioned offset correction and sensitivity correction data. The phase contrast image generation unit 61 generates a phase contrast image based on the image signals on which the correction has been performed.

Next, a method for generating a phase contrast image at the phase contrast image generation unit 61 will be described. First, the principle of the method for generating a phase contrast image in the present embodiment will be described.

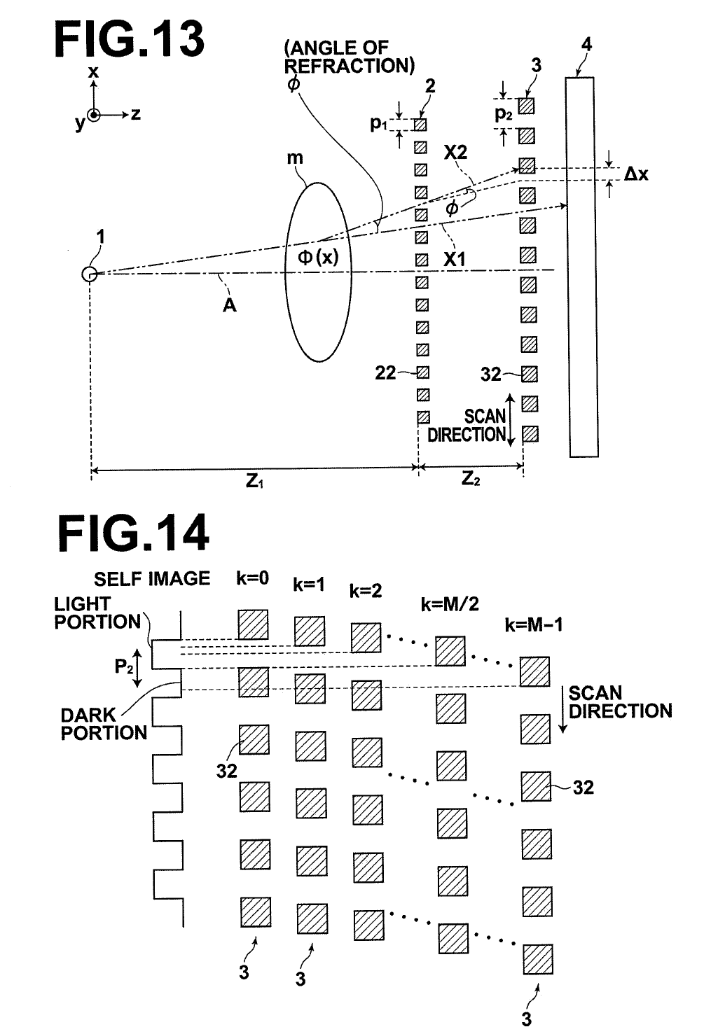

FIG. 13 is a diagram illustrating a path of a ray of radiation refracted based on phase shift distribution Φ(x) related to X direction of subject m to be examined. In FIG. 13, sign X1 indicates a path of radiation when subject m to be examined is not present, and the radiation travels straight. The radiation traveling through the path X1 passes through the first grating 2 and the second grating 3, and enters the radiation image detector 4. Sign X2 indicates a path of radiation when the subject m to be examined is present, and the radiation has been refracted by the subject m to be examined and deflected. The radiation traveling through the path X2 passes through the first grating 2, and is blocked by the second grating 3.

The phase shift distribution Φ(x) of the subject m to be examined is represented by the following formula (12) when the distribution of refractive index of the subject m to be examined is n (x,z), and the direction in which radiation travels is z. Here, y coordinate is omitted to simplify explanation.

$$\begin{matrix}[ FORMULA 12 ] & \\ Φ ( x ) = \frac{2 π}{λ} \int [ 1 - n ( x , z ) ] d z & ( 12 )\end{matrix}$$

Self image G1 of the first grating 2 formed at the position of the second grating 3 is displaced by refraction of radiation by the subject m to be examined. The self image G1 is displaced, in X direction, by an amount corresponding to angle φ of refraction of radiation. Displacement amount Δx is approximated by the following formula (13) based on the premise that the angle φ of refraction of radiation is minute:

### [FORMULA 13]

Δx≈Z₂φ (13)

Here, the angle φ of refraction is represented by the following formula (14) by using wavelength λ of radiation and phase shift distribution Φ(x) of subject m to be examined:

$$\begin{matrix}[ FORMULA 14 ] & \\ ϕ = \frac{λ}{2 π} \frac{\partial Φ ( x )}{\partial x} . & ( 14 )\end{matrix}$$

As described above, displacement amount Δx of self image G1 by refraction of radiation by the subject m to be examined is related to phase shift distribution Φ(x) of the subject m to be examined. Further, the displacement amount Δx is related to phase shift amount Ψ of an intensity-modulated signal of each pixel detected by the radiation image detector 4 (a phase shift amount of an intensity-modulated signal of each pixel between a case with subject m to be examined and a case without the subject m), as represented in the following formula (15):

$$\begin{matrix}[ FORMULA 15 ] & \\ ψ = \frac{2 π}{{P}_{2}} Δ x = \frac{2 π}{{P}_{2}} {Z}_{2} ϕ . & ( 15 )\end{matrix}$$

Therefore, it is possible to obtain angle φ of refraction by obtaining phase shift amount Ψ of the intensity-modulated signal of each pixel by the formula (15). Further, the differential value of phase shift distribution Φ(x) is obtainable by using the formula (14). Further, it is possible to obtain phase shift distribution Φ(x) of the subject m to be examined by integrating the differential value with respect to x. In other words, it is possible to generate a phase contrast image of the subject m to be examined. In the present embodiment, the phase shift amount Ψ is calculated by a fringe scan method as described below.

In the fringe scan method, radiography as described above is performed while one of the first grating 2 and the second grating 3 is translationally moved, in X-direction, relative to the other one of the first grating 2 and the second grating. In the present embodiment, the second grating 3 is moved by the aforementioned scan mechanism 5. As the second grating 3 moves, a fringe image detected by the radiation image detector 4 moves. When the distance of the translational motion (a movement amount in X direction) reaches an arrangement cycle (arrangement pitch P₂) of the second grating 3, in other words, when a change in phase reaches 2π, the fringe image returns to the original position. Such a change in the fringe image is detected by the radiation image detector 4 while the second grating 3 is moved, step by step, by a distance of 1/(the integer of arrangement pitch P₂). Accordingly, the fringe images are detected at the radiation image detector 4. Further, the intensity-modulated signal of each pixel is obtained from the detected plural fringe images, and phase shift amount Ψ of the intensity-modulated signal of each pixel is obtained.

FIG. 14 is a schematic diagram illustrating the manner of moving the second grating 3, step by step, by a movement pitch (P₂/M) which is obtained by dividing arrangement pitch P₂ by M (integer greater than or equal to 2). The scan mechanism 5 translationally moves the second grating 3 to each of M positions (k=0, 1, 2, . . . , M−1) in this order. In FIG. 10, a position (k=0) at which a dark portion of the self image of the first grating 2 when subject m to be examined is not present substantially coincides with the member 32 of the second grating 3 is regarded as an initial position of the second grating 3. However, any position k=0, 1, 2, . . . , M−1 may be regarded as the initial position.

First, at the position of k=0, radiation that has not been refracted by the subject m to be examined mainly passes through the second grating 3. As the second grating 3 is moved to k=1, 2, . . . in this order, in radiation that passes through the second grating 3, a component of radiation that has not been refracted by the subject m to be examined decreases, and a component of radiation that has been refracted by the subject m to be examined increases. Especially, when k=M/2, only the component of radiation that has been refracted by the subject m to be examined mainly passes through the second grating 3. However, when k exceeds M/2, in radiation that passes through the second grating 3, a component of the radiation refracted by the subject m to be examined decreases, and a component of the radiation that has not been refracted by the subject m to be examined increases.

Further, M fringe image signals (M is the number of images), representing M fringe images, are obtained by performing radiography at each position of k=0, 1, 2, . . . , M−1 by the radiation image detector 4. The obtained fringe image signals are stored in the phase contrast image generation unit 61.

Next, a method for calculating phase shift amount Ψ of the intensity-modulated signal of each pixel based on the pixel signal of each pixel of the M fringe image signals will be described.

First, pixel signal Ik(x) of each pixel at position k of the second grating 3 is represented by the following formula (16):

$$\begin{matrix}[ FORMULA 16 ] & \\ {I}_{k} ( x ) = {A}_{0} + {\sum }_{n > 0} {A}_{n} exp [ 2 π i \frac{n}{{P}_{2}} \{ {Z}_{2} ϕ ( x ) + \frac{{kP}_{2}}{M} \} ] . & ( 16 )\end{matrix}$$

Here, x represents the coordinate of a pixel related to x direction, and A₀ represents the intensity of incident radiation. Aₙ is a value corresponding to the contrast of the intensity-modulated signal (here, n is a positive integer). Further, φ(x) is the angle φ of refraction represented as a function of coordinate x of a pixel of the radiation image detector 4.

Next, when a relational equation represented by the following formula (17) is used, the angle φ(x) of refraction is represented as in formula (18):

$$\begin{matrix}[ FORMULA 17 ] & \\ {\sum }_{k = 0}^{M - 1} exp ( - 2 π i \frac{k}{M} ) = 0 & ( 17 ) \\ [ FORMULA 18 ] & \\ ϕ ( x ) = \frac{{p}_{2}}{2 π {Z}_{2}} arg [ {\sum }_{k = 0}^{M - 1} {I}_{k} ( x ) exp ( - 2 π i \frac{k}{M} ) ] . & ( 18 )\end{matrix}$$

Here, “arg [ ]” means extraction of an argument, which corresponds to phase shift amount W of each pixel of the radiation image detector 4. Therefore, it is possible to obtain angle φ(x) of refraction by calculating, based on the formula (18), the phase shift amount Ψ of the intensity-modulated signal of each pixel of the phase contrast image from the pixel signals of the M fringe image signals obtained for each pixel of the radiation image detector 4.

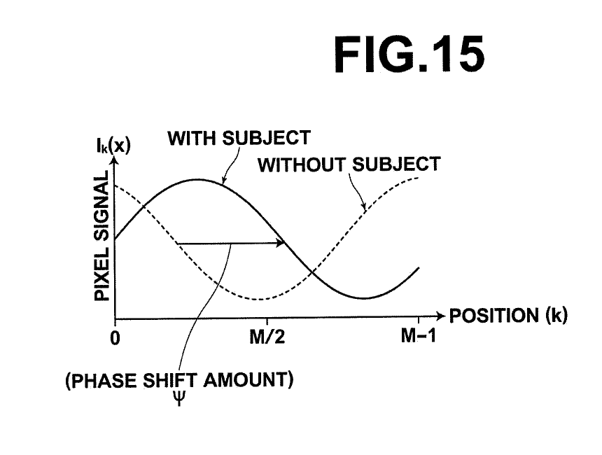

Specifically, as illustrated in FIG. 15, M pixel signals obtained for each pixel of the radiation image detector 4 periodically change with respect to position k of the radiation image detector 4 at a cycle of grating pitch P₂ of the second grating 2. In FIG. 15, a broken line indicates a change in pixel signals when subject m to be examined is not present, and a solid line indicates a change in pixel signals when subject m to be examined is present. A phase difference between the waveforms of the two lines corresponds to phase shift amount Ψ of the intensity-modulated signals of each pixel.

Specifically, phase shift amount Ψ, which is a difference between each pixel signal of M fringe image signals obtained by the aforementioned radiography and each pixel signal of M calibration data (M is the number of images) obtained by the calibration data obtainment unit 63, is calculated. Further, the angle γ (x) of refraction is calculated based on the phase shift amount T.

The angle φ(x) of refraction corresponds to the differential value of phase shift distribution Φ(x), as represented by the formula (14). Therefore, it is possible to obtain phase shift distribution Φ(x) by integrating the angle φ(x) of refraction along x axis.

In the above descriptions, y coordinate of the pixel related to y direction was not considered. However, it is possible to obtain two-dimensional distribution φ(x,y) of the angle of refraction by performing a similar operation also for each y coordinate. Further, it is possible to obtain two-dimensional phase shift distribution Φ(x,y), as a phase contrast image, by integrating the two-dimensional distribution φ(x,y) along x axis.

Alternatively, the phase contrast image may be generated by integrating two-dimensional distribution Ψ(x,y) of the phase shift amount along x axis, instead of the two-dimensional distribution φ(x,y) of the angle of refraction.

Since the two-dimensional distribution φ(x,y) of the angle of refraction and the two-dimensional distribution Ψ(x,y) of the phase shift amount correspond to the differential value of phase shift distribution Φ(x,y), they are called as phase differential images. The phase differential images may be generated as phase contrast images.

As described above, the phase contrast image generation unit 61 generates a phase contrast image based on plural fringe images (step S20).

The mammography system in the aforementioned embodiment may be structured in such a manner that the detector unit 17 is changeable. When the detector unit 17 is changeable, the offset correction data and the sensitivity correction data of the radiation image detector 4 differ depending on the detector unit 17 set in the mammography system. Therefore, a correspondence table of magnification ratios and calibration data, as illustrated in FIG. 7, may be provided for each detector unit 17.

Further, information about the set detector unit 17 should be obtained, and calibration data should be obtained based on the obtained information and the set magnification ratio that has been input. The information about the detector unit 17 may be input by the radiographer by using the input unit 50. Alternatively, the information may be stored, in advance, in each detector unit 17, and the information may be obtained by reading out the stored information.

In the mammography system of the aforementioned embodiment, calibration data corresponding to each magnification ratio are stored in advance. However, it is not necessary that the calibration data are stored in advance. Alternatively, radiography for obtaining calibration data may be performed after the radiographer has input a set magnification ratio and the detector unit 17 has moved to a position corresponding to the input magnification ratio. The calibration data are obtained by outputting radiation toward the first grating 2 and the second grating 3 before breast m is placed. In other words, radiography for obtaining calibration data may be performed in each time when a magnification ratio is set by the radiographer. In radiography for obtaining the calibration data, the control unit 60 may detect a change in the magnification ratio obtained by the magnification ratio obtainment 62, and radiography for obtaining calibration data may be performed automatically based on the detection. In this case, for example, when the magnification ratio is changed, the control unit 60 may display, on the monitor 40, a message for prompting re-radiography for obtaining calibration data. Then, an instruction to perform radiography for obtaining calibration data may be input by a user (a radiographer, an operator or the like) who has seen the message. In this manner, the control unit 60 should automatically start radiography for calibration.

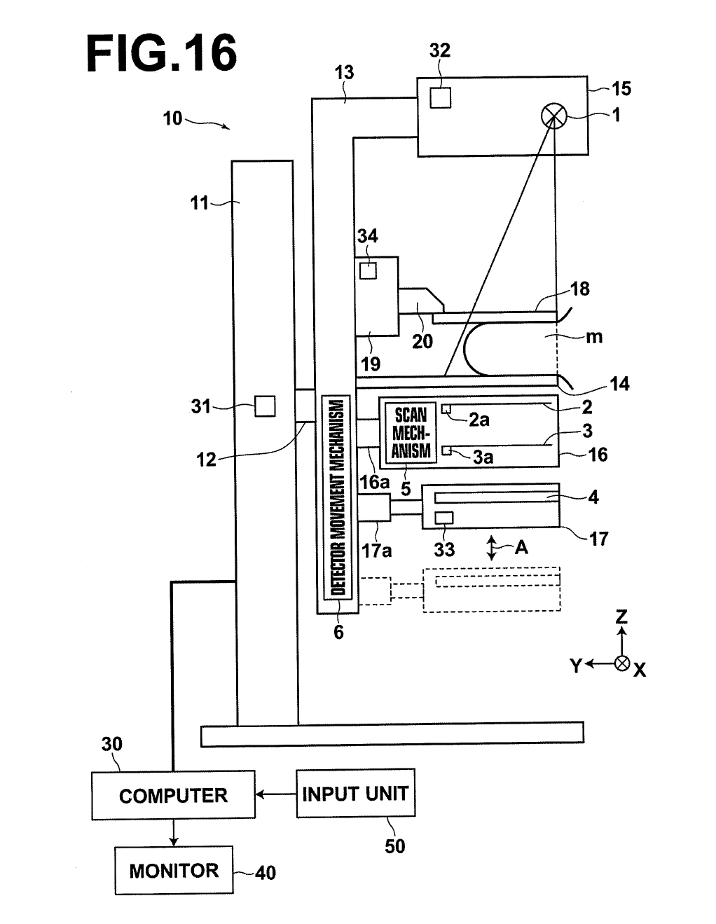

Further, as illustrated in FIG. 16, in the mammography system in the aforementioned embodiment, displacement detection units 2a, 3a for detecting displacements in the positions of the first grating 2 and the second grating 3 in the grid unit 16 may be provided in the grid unit 16. When displacement amounts detected by the displacement detection units 2a, 3a are less than predetermined threshold values, calibration data that have been stored in advance may be used. Only when the displacement amount or amounts are greater than or equal to the predetermined threshold value or values, re-radiography for obtaining calibration data should be performed to obtain calibration data again. For example, the displacement detection units 2a, 3a may be structured by using an optical sensor, an acceleration sensor, or the like. Alternatively, pre-radiation may be performed, and a so-called moire pattern generated by displacements in the positions of the first grating 2 and the second grating 3 may be detected by the radiation image detector 4. In this manner, displacements in the positions of the first grating 2 and the second grating 3 may be detected.

The radiation phase image radiographic apparatus in the aforementioned embodiment is structured in such a manner that distance Z₂ from the first grating 2 to the second grating 3 becomes a Talbot interference distance. However, it is not necessary that the radiation phase image radiographic apparatus is structured in such a manner. Alternatively, the radiation phase image radiographic apparatus may be structured in such a manner that the first grating 2 projects incident radiation without diffracting the radiation. When the radiation phase image radiographic apparatus is structured in such a manner, similar projection images of radiation projected through the first grating 2 are obtainable at all positions on the back side of the first grating 2. Therefore, it is possible to set the distance Z₂ from the first grating 2 to the second grating 3 without regard to the Talbot interference distance.

Specifically, both the first grating 2 and the second grating 3 are structured as absorption-type (amplitude modulation type) gratings. Further, the apparatus is structured in such a manner that radiation that has passed through a slit portion is geometrically projected without regard to whether a Talbot interference effect is present or not. More specifically, it is possible to structure the apparatus so that most of radiation output from the radiation source 1 is not diffracted by the slit portions by setting, as interval d₁ of the first grating 2 and interval d₂ of the second grating 3, values sufficiently larger than the peak wavelength of radiation output from the radiation source 1. The radiation that has been output from the radiation source 1 and that has not been diffracted travels straight through the slit portions. For example, when tungsten is used as a target of the radiation source, and tube voltage is 50 kV, the peak wavelength of radiation is approximately 0.4 Å. In this case, most of radiation is not diffracted at the slit portions, and the radiation is geometrically projected when the interval d₁, of the first grating 2 and the interval d₂ of the second grating 3 are approximately in the range of 1 μm to 10 μm.

With respect to the relationship between grating pitch P₁ of the first grating 2 and grating pitch P₂ of the second grating 3 and the relationship between interval d₁ of the first grating 2 and interval d₂ of the second grating 3, the apparatus is structured in a manner similar to the first embodiment.

In the radiation phase image radiographic apparatus structured as described above, distance Z₂ between the first grating 2 and the second grating 3 may be set shorter than a minimum Talbot interference distance when m=1 in the formula (6). Specifically, the distance Z₂ is set so as to satisfy the range represented by the following formula (19):

$$\begin{matrix}[ FORMULA 19 ] & \\ {Z}_{2} < \frac{{P}_{1} {P}_{2}}{λ} . & ( 19 )\end{matrix}$$

It is desirable that the members 22 of the first grating 2 and the members 32 of the second grating 3 completely block (absorb) radiation to generate a high-contrast periodic pattern image. However, even if a material (gold, platinum or the like) that excellently absorbs radiation is used, the amount of radiation that passes through the gratings without being absorbed is not small. Therefore, it is desirable that thicknesses h₁, h₂ of the members 22, 32 are as thick as possible to increase the radiation blocking characteristic of the members 22, 32. It is desirable that the members 22, 32 block at least 90% of radiation that have irradiated the members 22, 32. For example, when the tube voltage of the radiation source 1 is 50 kV, it is desirable that the thicknesses h₁, h₂ are greater than or equal to 30 μm in gold (Au) equivalent.

However, a problem of so-called vignetting of radiation exists in a manner similar to the aforementioned embodiment. Therefore, the thickness h₁, h₂ of the members 22 of the first grating 2 and the members 32 of the second grating 3 are limited.

In the radiation phase image radiographic apparatus structured as described above, it is possible to make distance Z₂ between the first grating 2 and the second grating 3 shorter than a Talbot interference difference. Therefore, it is possible to further reduce the thickness of the radiographic apparatus, compared with the radiation phase image radiographic apparatus in the aforementioned embodiment that needs to maintain a certain Talbot interference distance.

Further, in the mammography system in the aforementioned embodiment, the detector unit 17 is moved alone without changing the position of the radiation source when magnification radiography is performed. However, when both of the first grating 2 and the second grating 3 are structured as absorption-type (amplitude modulation type) gratings, and the apparatus is structured in such a manner to geometrically project radiation that has passed through the slit portion without regard to whether a Talbot interference effect is present or not, as described above, the radiation source unit 15 may be moved synchronously with the movement of the detector unit 17 in the same direction.

Further, in the aforementioned embodiment, the second grating 3 is translationally moved by the scan mechanism 5 in the grid unit 16, and radiography are performed, more than once, to obtain plural fringe image signals for generating a phase contrast image. However, it is not necessary that the second grating 3 is translationally moved. Plural fringe image signals may be obtained by performing only one radiography operation.

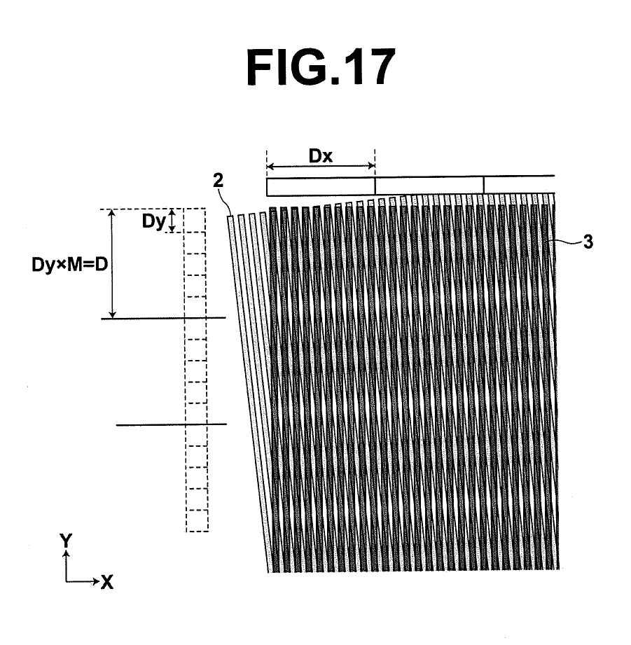

Specifically, as illustrated in FIG. 17, the first grating 2 and the second grating 3 are arranged in such a manner that a direction in which the first grating 2 extends and a direction in which the second grating 3 extends incline relative to each other. With respect to the first grating 2 and the second grating 3 arranged in such a manner, the relationship between main pixel size Dx in a main scan direction (X direction in FIG. 17) and sub pixel size Dy in a sub scan direction of each pixel of an image signal detected by the radiation image detector 4 is as illustrated in FIG. 17.

For example, when a radiation image detector using a so-called optical readout method is used, the main pixel size Dx is determined by the arrangement pitch of linear electrodes of the radiation image detector. The radiation image detector using the so-called optical readout method includes many linear electrodes, and the radiation image detector is scanned by a linear readout light source that is arranged to extend in a direction orthogonal to a direction in which the linear electrodes extend. Accordingly, image signals are read out. Further, the sub pixel size Dy is determined by the width of linear readout light output to the radiation image detector from the linear readout light source. Further, when a radiation image detector using a so-called TFT readout method or a radiation image detector using a CMOS (complementary metal-oxide semiconductor) is used, the main pixel size Dx is determined by the arrangement pitch of pixel circuits in the arrangement direction of data electrodes from which image signals are read out. The sub pixel size Dy is determined by the arrangement pitch of pixel circuits in the arrangement direction of gate electrodes from which gate voltage is output.

Further, when the number of fringe images for generating a phase contrast image is M, the first grating 2 is inclined relative to the second grating 3 in such a manner that M sub pixel sizes Dy (Dy×M) becomes one image resolution D in the sub scan direction of the phase contrast image.

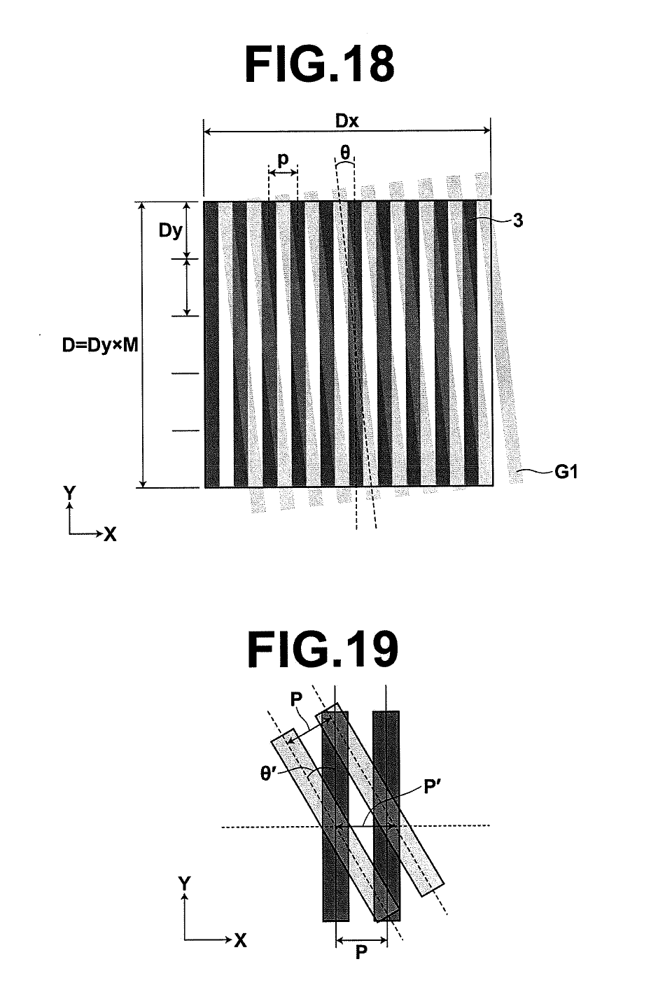

Specifically, as illustrated in FIG. 18, when the pitch of the second grating 3 and the pitch of self image G1 of the first grating 2 formed by the first grating 2 at the position of the second grating 3 are p, a relative rotation angle of the self image of the first grating 2 with respect to the second grating 3 in X-Y plane is θ, and an image resolution of a phase contrast image in a sub scan direction is D (=Dy×M), if the rotation angle θ is set so as to satisfy the following formula (20), the phase of the self image G1 of the first grating 2 and the phase of the second grating 2 are shifted, by n cycle, with respect to the length of the image resolution D in the sub scan direction. FIG. 18 illustrates a case in which M=5, and n=1.

$$\begin{matrix}[ FORMULA 20 ] & \\ θ = arctan \{ n \times \frac{p}{D} \} & ( 20 )\end{matrix}$$

where n is an integer excluding both 0 and multiples of M.

Therefore, each pixel of Dx×Dy, obtained by dividing image resolution D in the sub scan direction of the phase contrast image by M, can detect an image signal obtainable by dividing an intensity-modulated self image of the first grating 2 for n cycle (n is the number of cycles) by M. In the example illustrated in FIG. 18, n=1. Therefore, the phase of self image G1 of the first grating 2 and the phase of the second grating 3 are shifted by a cycle with respect to the length of the image resolution D in the sub scan direction. In simpler words, a range (area) of the self image G1 of the first grating 2 for one cycle, the range passing through the second grating 3, changes through the length of the image resolution D in the sub scan direction.

Further since M=5, each pixel of Dx×Dy can detect an image signal obtainable by dividing intensity-modulated self image of the first grating 2 for one cycle by 5. In other words, pixels of Dx×Dy can detect image signals of 5 fringe images that are different from each other, respectively.

In the present embodiment, Dx=50 μm, Dy=10 μm, and M=5, as described above. Therefore, the image resolution Dx in the main scan direction of the phase contrast image and the image resolution D=Dy×M in the sub scan direction are the same. However, it is not necessary that the image resolution Dx in the main scan direction and the image resolution D in the sub scan direction are the same, and they may have an arbitrary ratio between the main scan direction and the sub scan direction.

In the present embodiment, M=5. However, it is not necessary that the value of M is 5 as long as the value of M is greater than or equal to 3. In the above descriptions, n=1. However, it is not necessary that the value of n is 1 as long as the value of n is an integer other than 0. Specifically, when the value of n is a negative integer, the direction of rotation is opposite to the direction in the aforementioned example. Further, n may be an integer other than ±1, and the intensity modulation may be performed for n cycles. However, a case in which the value of n is a multiple of M should be excluded, because the phase of the self image G1 of the first grating 2 and the phase of the second grating 3 become the same among a set of M sub scan direction pixels Dy, and different M fringe images are not formed.

Further, rotation angle θ of the self image of the first grating 2 with respect to the second grating 3 may be adjusted, for example, by rotating the first grating 2 after the relative rotation angle between the radiation image detector 4 and the second grating 3 is fixed.

For example, when p=5 μm, D=50 μm, and n=1 in the formula (20), theoretical rotation angle θ is approximately 5.7°. Further, actual rotation angle θ′ of the self image of the first grating 2 with respect to the second grating 3 may be detected, for example, based on the pitch of a moire pattern formed by the self image of the first grating 2 and the second grating 3.

Specifically, as illustrated in FIG. 19, when the actual rotation angle is θ′, and an observed pitch of a self image in X direction generated by rotation is P′, pitch Pm of observed moire is as follows:

1/Pm=|1/P′−1/P|.

Therefore, when P′=P/cos θ′ is substituted for P′ in the equation, it is possible to obtain the actual rotation angle θ′. Further, the pitch Pm of the moire should be obtained based on image signals detected by the radiation image detector 4.

Further, the theoretical rotation angle θ and the actual rotation angle θ′ should be compared with each other, and the rotation angle of the first grating 2 should be corrected automatically or manually by the difference between the theoretical rotation angle θ and the actual rotation angle θ′.

Further, in the radiation phase image radiographic apparatus structured as described above, after image signals for a whole one frame are read out from the radiation image detector 4, and stored in the phase contrast image generation unit 61, image signals representing 5 fringe images that are different from each other are obtained based on the stored image signals.

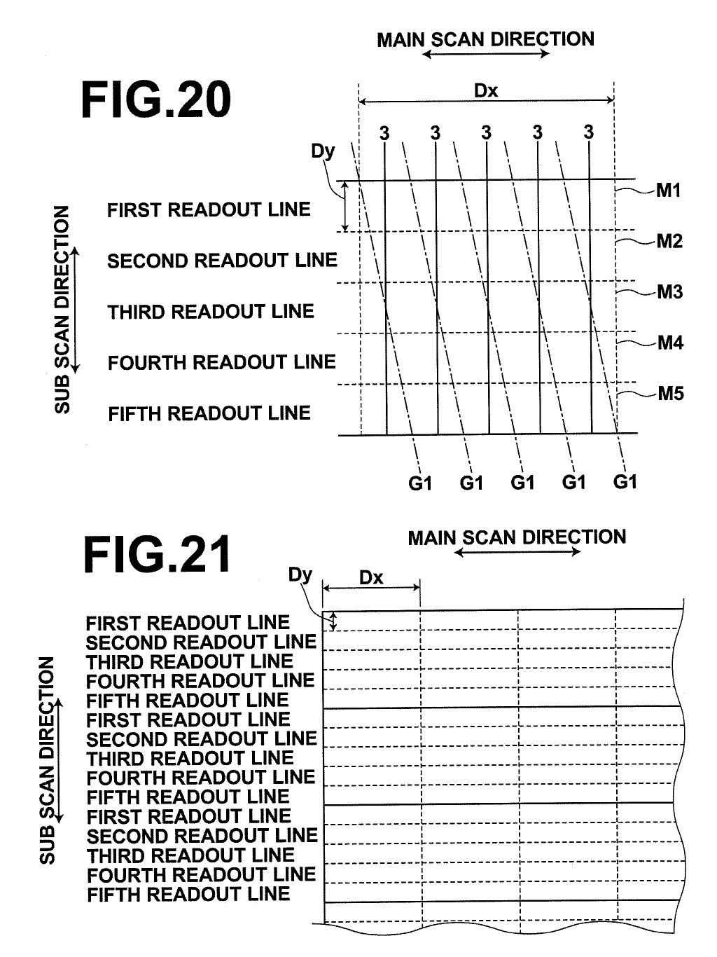

Specifically, as illustrated in FIG. 18, image resolution D in sub scan direction of the phase contrast image is divided by 5, and the first grating 2 is inclined relative to the second grating 3 so that image signals obtainable by dividing intensity-modulated self image of the first grating 2 for a cycle by 5 are detectable. In such a case, as illustrated in FIG. 20, an image signal read out from a first readout line is obtained as first fringe image signal M1, an image signal read out from a second readout line is obtained as second fringe image signal M2, an image signal read out from a third readout line is obtained as third fringe image signal M3, an image signal read out from a fourth readout line is obtained as fourth fringe image signal M4, and an image signal read out from a fifth readout line is obtained as fifth fringe image signal M5. The first through fifth readout lines illustrated in FIG. 20 correspond to sub pixel size Dy illustrated in FIG. 18.

In FIG. 20, only a readout range of Dx×(Dy×5) is illustrated. However, the first through fifth fringe image signals are obtained also in other readout ranges in a similar manner. Specifically, as illustrated in FIG. 21, image signals representing a group of pixel rows (readout lines) with 4 pixel intervals between pixel rows in the sub scan direction are obtained, as a frame of one-fringe-image signal. More specifically, image signals of a group of pixel rows of first readout lines are obtained, as a frame of first fringe image signal. Image signals of a group of pixel rows of second readout lines are obtained, as a frame of second fringe image signal. Image signals of a group of pixel rows of third readout lines are obtained, as a frame of third fringe image signal. Image signals of a group of pixel rows of fourth readout lines are obtained, as a frame of fourth fringe image signal. Image signals of a group of pixel rows of fifth readout lines are obtained, as a frame of fifth fringe image signal.

Further, with respect to calibration data, calibration data representing 5 images for calibration are obtained by performing one radiography operation in a manner similar to the main radiography operation as described above.

Further, the phase contrast image generation unit 61 generates a phase contrast image based on the first through fifth fringe image signals and the calibration data representing 5 images for calibration.

In the above descriptions, as illustrated in FIG. 17, an image obtained by radiography while the direction in which the first grating 2 extends and the direction in which the second grating 3 extends incline relative to each other is used. Further, plural fringe image signals are obtained by obtaining image signals of groups of pixel rows, and the groups being different from each other, from the single image obtained by radiography. Further, a phase contrast image is generated by using the plural fringe image signals. However, instead of generating the plural fringe image signals based on the single image obtained by radiography, as described above, a phase contrast image may be generated also by performing Fourier transformation on the single image obtained by radiography as described above. Such a method may be adopted.

Specifically, first, Fourier transformation is performed on an image obtained by radiography while a direction in which the first grating 2 extends and a direction in which the second grating 3 extends incline relative to each other. By performing Fourier transformation on the image, absorption information and phase information by subject m to be examined included in the image are separated.

Then, only the phase information by the subject m to be examined is extracted in frequency space, and moved to a center position (origin) in the frequency space. After then, inverse Fourier transformation is performed on the extracted phase information to obtain a result. Further, the imaginary part of the result is divided by the real part of the result, and arc tangent function of the division result (arc tan (imaginary part/real part)) is calculated. Accordingly, it is possible to obtain phase shift distribution Φ(x,y). Further, it is possible to obtain a phase differential image by differentiating the phase shift distribution Φ(x,y).

Further, in the radiation phase image radiographic apparatus in the aforementioned embodiment, two gratings, namely, the first grating 2 and the second grating 3 are used. However, it is possible to omit the second grating 3 by providing the function of the second grating 3 in a radiation image detector. Next, the structure of a radiation image detector having the function of the second grating 3 will be described.

In the radiation image detector having the function of the second grating 3, a self image of the first grating 2 formed by the first grating 2 by passing radiation through the first grating 2 is detected. Further, charge signals corresponding to the self image are stored in a charge storage layer divided in grid form, which will be described later. Accordingly, the intensity of the self image is modulated, and a fringe image is generated. The generated fringe image is output as an image signal.

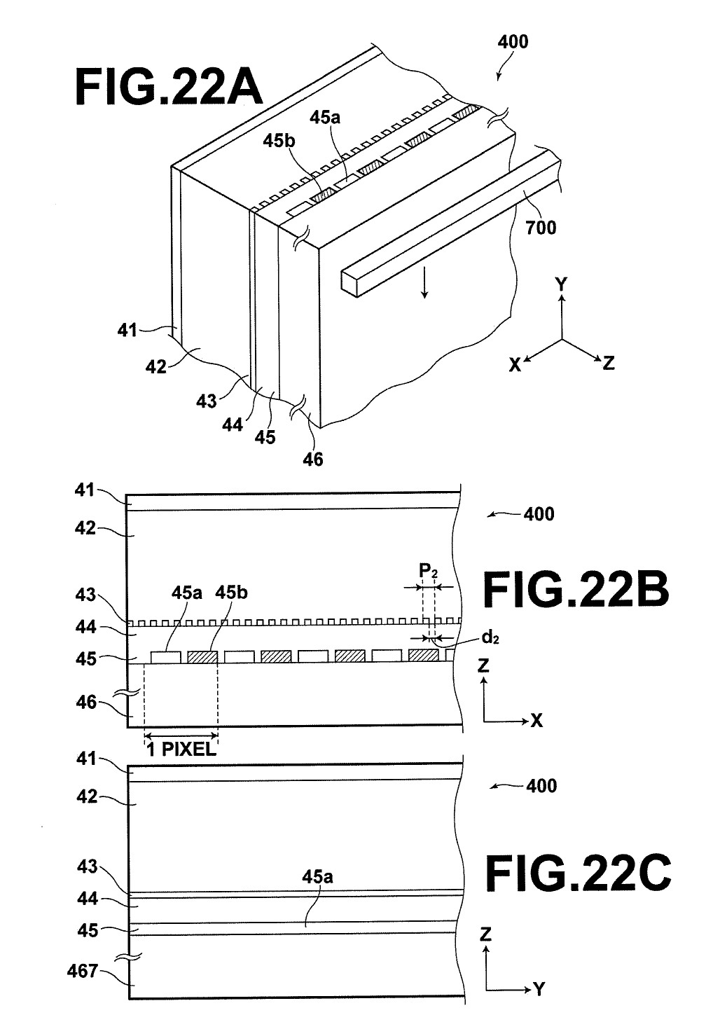

FIG. 22A is a perspective view of a radiation image detector 400 having a function of the second grating 3. FIG. 22B is an XY-plane cross section of the radiation image detector 400 illustrated in FIG. 22A. FIG. 22C is a YZ-plane cross section of the radiation image detector 400 illustrated in FIG. 22A.

As illustrated in FIG. 22A through 22C, the radiation image detector 400 includes a first electrode layer 41, a photoconductive layer 42 for recording, a charge storage layer 43, a photoconductive layer 44 for readout, and a second electrode layer 45, which are placed one on another in this order. The first electrode layer 41 passes radiation, and the photoconductive layer 42 for recording generates charges by irradiation with radiation that has passed through the first electrode layer 41. The charge storage layer 43 acts as an insulator for charges of one of the polarities of the charges generated in the photoconductive layer 42 for recording, and acts as a conductor for charges of the opposite polarity. Further, the photoconductive layer 44 for readout generates charges by irradiation with readout light. These layers are formed on a glass substrate 46 in the mentioned order with the second electrode layer 45 at the bottom.

The first electrode layer 41 should pass radiation. For example, NESA coating (SnO₂), ITO (Indium Tin Oxide), IZO (Indium Zinc Oxide), IDIXO (Idemitsu Indium X-metal Oxide; Idemitsu Kosan, Co., Ltd.), which is an amorphous light-transmissive oxide coating, or the like may be formed in a thickness of 50 to 200 nm, as the first electrode layer 41. Alternatively, Al, Au, or the like with a thickness of 100 nm or the like may be used as the first electrode layer 41.

The photoconductive layer 42 for recording should generate charges by irradiation with radiation. A material containing a-Se, as a main component, may be used, because a-Se has a relatively high quantum efficiency with respect to radiation, and dark resistance is high. An appropriate thickness of the photoconductive layer 42 for recording is greater than or equal to 10 μm and less than or equal to 1500 μm. Especially, when the apparatus is used for mammography, it is desirable that the thickness of the photoconductive layer 42 for recording is greater than or equal to 150 μm and less than or equal to 250 μm. For general radiography use, it is desirable that the thickness of the photoconductive layer 42 for recording is greater than or equal to 500 μm and less than or equal to 1200 μm.

The charge storage layer 43 should have insulation properties with respect to charges having a polarity to be stored. The charge storage layer 43 may be made of polymers, such as an acryl-based organic resin, polyimide, BCB, PVA, acryl, polyethylene, polycarbonate and polyetherimide, sulfides, such as As₂S₃, Sb₂S₃ and ZnS, oxides, fluorides or the like. Further, it is more desirable that the charge storage layer 43 has insulation properties with respect to charges having a polarity to be stored, but conduction properties with respect to charges of the opposite polarity. Further, it is desirable to use a substance in which the product of mobility by lifetime differs, depending on the polarity of charges, at least by three digits.

Examples of an appropriate compound for the charge storage layer 43 are As₂Se₃, a compound obtained by doping As₂Se₃ with C1, Br, or I in the range of 500 ppm to 20000 ppm, As₂(SeₓTe₁₋ₓ)₃ (0.5<x<1) which is obtained by substituting Se in As₂Se₃ with Te up to approximately 50%, a compound obtained by substituting Se in As₂Se₃ with S up to approximately 50%, AsₓSe_{y} (x+y=100, 34≦x≦46), which is obtained by changing the As concentration of As₂Se₃ by approximately ±15%, an amorphous Se—Te-based compound containing Te at 5 to 30 wt %, and the like.

It is desirable that the dielectric constant of the material of the charge storage layer 43 is greater than or equal to a half of the dielectric constants of the photoconductive layer 42 for recording and the photoconductive layer 44 for readout, and less than or equal to twice the dielectric constants of the photoconductive layer 42 for recording and the photoconductive layer 44 for readout so that an electric line of force formed between the first electrode layer 41 and the second electrode layer 45 does not curve.

Further, as illustrated in FIGS. 22A through 22C, the charge storage layer 43 is divided in linear form parallel to a direction in which transparent linear electrodes 45a and light-blocking linear electrodes 45b in the second electrode layer 45 extend.

The charge storage layer 43 is divided with a pitch narrower than the arrangement pitch of the transparent linear electrodes 45a or the light-blocking linear electrodes 45b. Arrangement pitch P₂ and interval d₂ of the charge storage layer 43 are similar to the conditions of the second grating 3 in the aforementioned embodiment.

Further, the thickness of the charge storage layer 43 is less than or equal to 2 μm in a direction in which the layer is deposited (Z direction).

For example, the charge storage layer 43 may be formed by resistance heating vapor deposition by using the aforementioned materials and a metal mask or a mask formed by fibers or the like. The metal mask is obtained by forming a hole (an opening, a slit or the like) in a metal plate. Alternatively, the charge storage layer 43 may be formed by photolithography.

The photoconductive layer 44 for readout should exhibit conductivity by receiving readout light. For example, a photoconductive material containing, as a main component, at least one of a-Se, Se—Te, Se—As—Te, non-metal phthalocyanine, metal phthalocyanine, MgPc (Magnesium phtalocyanine), VoPc (phase II of Vanadyl phthalocyanine), CuPc (Copper phtalocyanine), and the like is appropriate. It is desirable that the thickness of the photoconductive layer 44 for readout is approximately 5 to 20 μm.

The second electrode layer 45 includes plural transparent linear electrodes 45a, which pass readout light, and plural light-blocking linear electrodes 45b, which block the readout light. The transparent linear electrodes 45a and the light-blocking linear electrodes 45b continuously extend in straight line form from an edge of an image formation area of the radiation image detector 400 to the opposite edge of the image formation area. As illustrated in FIGS. 22A and 22B, the transparent linear electrodes 45a and the light-blocking linear electrodes 45b are alternately arranged with a predetermined space therebetween.

The transparent linear electrodes 45a are made of a material that passes readout light and that has conductivity. For example, in a manner similar to the first electrode layer 41, ITO, IZO or IDIXO may be used. Further, the thickness of the transparent linear electrodes 45a is approximately 100 to 200 nm.

The light-blocking linear electrodes 45b are made of a material that blocks readout light and that has conductivity. For example, the aforementioned transparent conductive material and a color filter may be used in combination. The thickness of the transparent conductive material is approximately 100 to 200 nm.

As described later in detail, an image signal is read out at the radiation image detector 400 by using a pair of a transparent linear electrode 45a and a light-blocking linear electrode 45b arranged next to each other. Specifically, as illustrated in FIG. 22B, a pair of a transparent linear electrode 45a and a light-blocking linear electrode 45b is used to read out an image signal for a pixel. For example, the transparent linear electrodes 45a and the light-blocking linear electrodes 45b may be arranged so that a pixel is approximately 50 μm.

Further, as illustrated in FIG. 22A, a linear readout light source 700 that extends in a direction (X direction) orthogonal to a direction in which the transparent linear electrodes 45a and the light-blocking linear electrodes 45b extend is provided. The linear readout light source 700 includes a light source, such as an LED (Light Emitting Diode) or an LD (Laser Diode), and a predetermined optical system. The linear readout light source 700 is structured in such a manner to output linear readout light with a width of approximately 10 μm to the radiation image detector 400. The linear readout light source 700 is moved by a predetermined movement mechanism (not illustrated) in a direction (Y direction) in which the transparent linear electrodes 45a and the light-blocking linear electrodes 45b extend. By this movement of the linear readout light source 700, the radiation image detector 400 is scanned by linear readout light output from the linear readout light source 700, and image signals are read out.

With respect to a distance between the first grating 2 and the radiation image detector 400 for functioning as a Talbot interferometer, conditions are similar to those of the distance between the first grating 2 and the second grating 3, because the radiation image detector 400 functions as the second grating 3.

Next, the action of the radiation image detector 400 structured as described above will be described.

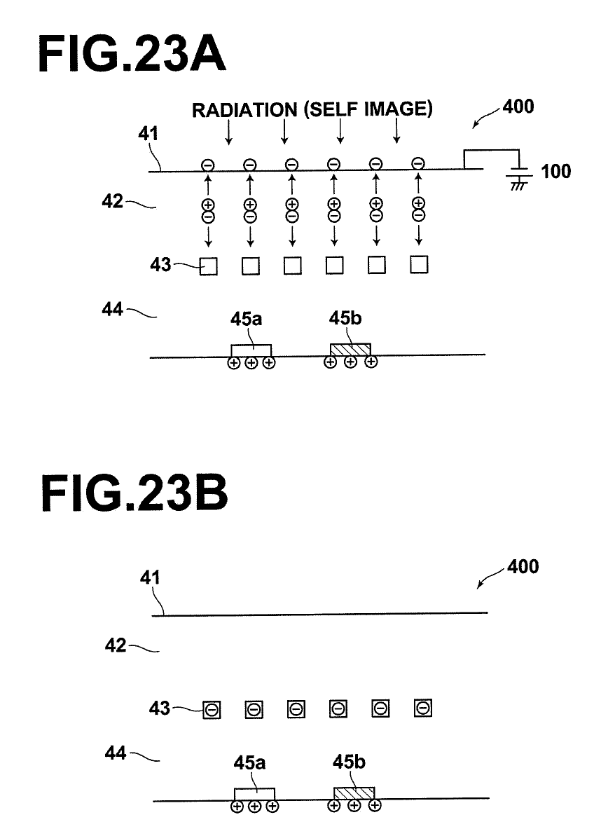

First, as illustrated in FIG. 23A, while negative voltage is applied to the first electrode layer 41 of the radiation image detector 400 by a high voltage source 100, radiation carrying a self image of the first grating 2 formed by a Talbot effect irradiates the radiation image detector 400 from the first electrode layer 41 side thereof.

The radiation that has irradiated the radiation image detector 400 passes through the first electrode layer 41, and irradiates the photoconductive layer 42 for recording. A pair of charges is generated in the photoconductive layer 42 for recording by irradiation with the radiation. A positive charge of the charge pair is combined with a negative charge in the first electrode layer 41, and disappears. A negative charge of the charge pair is stored in the charge storage layer 43 as a latent image charge (please refer to FIG. 23B).

Here, the charge storage layer 43 is divided in linear form with an arrangement pitch as described above. Therefore, among charges that have been generated based on the self image of the first grating 2 in the photoconductive layer 42 for recording, only charges with the charge storage layer 43 present just under the charges are trapped by the charge storage layer 43. Other charges pass through space (hereinafter, referred to as a non-charge-storage area) between linear patterns of the linear charge storage layer 43, and pass through the photoconductive layer 44 for readout. After the charges pass through the photoconductive layer 44 for readout, the charges flow out to the transparent linear electrodes 45a and the light-blocking linear electrodes 45b.

As described above, among charges generated in the photoconductive layer 42 for recording, only charges with the linear charge storage layer 43 present just under the charges are stored in the charge storage layer 43. Therefore, the intensity of the self image of the first grating 2 is modulated by overlapping with the linear patterns of the charge storage layer 43. Further, image signals of a fringe image reflecting a distortion of the wavefront of a self image by subject m to be examined are stored in the charge storage layer 43. In other words, the charge storage layer 43 achieves a function similar to the second grating 3 in the aforementioned embodiment.

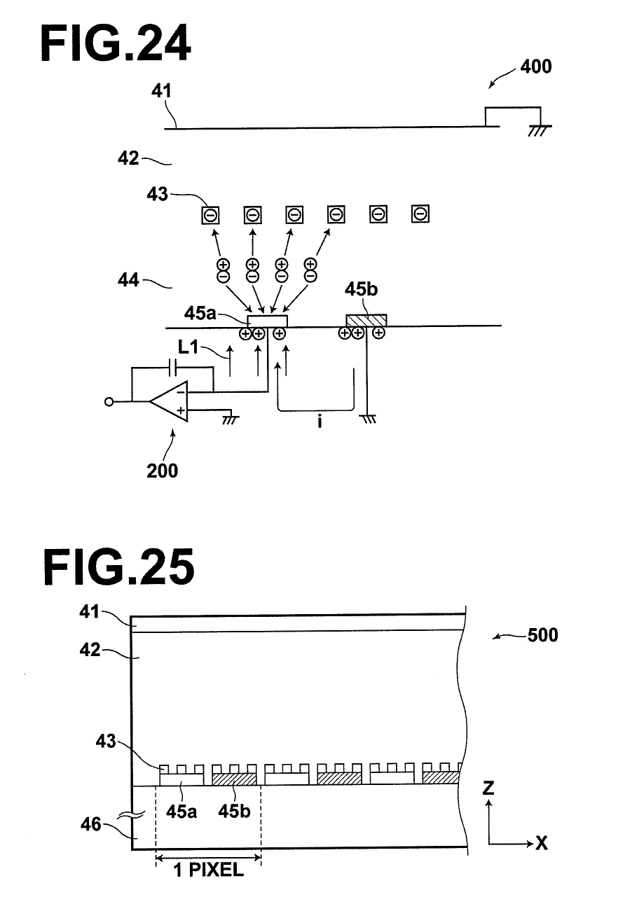

Next, as illustrated in FIG. 24, while the first electrode layer 41 is earthed, linear readout light L1 output from the linear readout light source 700 illuminates the radiation image detector 400 from the second electrode layer 45 side. The readout light L1 passes through the transparent linear electrodes 45a, and illuminates the photoconductive layer 44 for readout. Positive charges generated in the photoconductive layer 44 for readout by illumination with the readout light L1 are combined with latent image charges in the charge storage layer 43. Further, negative charges generated in the photoconductive layer 44 for readout by illumination with the readout light L1 are combined with positive charges in the light-blocking linear electrodes 45b through a charge amplifier 200 connected to the transparent linear electrodes 45a.

Since the negative charges generated in the photoconductive layer 44 for readout and the positive charges in the light-blocking linear electrodes 45b are combined with each other, an electric current flows to the charge amplifier 200. The electric current is integrated, and detected as image signals.

Further, the linear readout light source 700 moves in a sub scan direction (Y direction), and the radiation image detector 400 is scanned with the linear readout light L1. Further, image signals are sequentially detected for each readout line illuminated with the linear readout light L1 by the aforementioned action. The detected image signal for each readout line is sequentially input to the phase contrast image generation unit 61, and stored.

Further, the entire area of the radiation image detector 400 is scanned with readout light L1, and image signals for an entire one frame are stored in the phase contrast image generation unit 61.

In the radiation phase image radiographic apparatus in the aforementioned embodiment, the second grating 3 is translationally moved with respect to the first grating 2. In a similar manner, plural fringe images are obtainable by translationally moving the radiation image detector 400 having the aforementioned function of the second grating 3 with respect to the first grating 2.

Further, calibration data are obtainable by translationally moving the radiation image detector 400 having the function of the second grating 3.

Further, a phase contrast image is generated by the phase contrast image generation unit 61 based on 5 fringe image signals, representing 5 fringe images, and 5 calibration data sets, representing 5 calibration images.

In the radiation image detector 400 that has a function of the second grating 3 as described above, three layers of the photoconductive layer 42 for recording, the charge storage layer 43 and the photoconductive layer 44 for readout are provided between the electrodes. However, it is not necessary that the layers are structured in such a manner. For example, as illustrated in FIG. 25, the linear charge storage layer 43 may be provided directly on the transparent linear electrodes 45a and the light-blocking linear electrodes 45b of the second electrode layer without providing the photoconductive layer 44 for readout. Further, the photoconductive layer 42 for recording may be provided on the charge storage layer 43. The photoconductive layer 42 for recording functions also as a photoconductive layer for readout.

In this radiation image detector 500, the charge storage layer 43 is provided directly on the second electrode layer 45 without providing the photoconductive layer 44 for readout. In the radiation image detector 500, formation of the linear charge storage layer 43 is easy. Specifically, the linear charge storage layer 43 may be formed by vapor deposition. In the vapor deposition process, a metal mask or the like is used to selectively form a linear pattern. However, when the radiation image detector is structured in such a manner to provide the linear charge storage layer 43 on the photoconductive layer 44 for readout, a metal mask is set after vapor deposition of the photoconductive layer 44 for readout. Therefore, an operation in air between the vapor deposition process of the photoconductive layer 44 for readout and the vapor deposition process of the photoconductive layer 42 for recording may make the photoconductive layer 44 for readout deteriorate. Further, there is a risk of lowering the quality of the radiation image detector by mixture of a foreign substance between the photoconductive layers. When the photoconductive layer 44 for readout is not provided, as described above, it is possible to reduce the operation in air after vapor deposition of the photoconductive layer. Hence, it is possible to reduce the risk of deterioration in the quality, as described above.

The material of the photoconductive layer 42 for recording and the material of the charge storage layer 43 are similar to those in the aforementioned radiation image detector 400. Further, the linear structure of the charge storage layer 43 is similar to the aforementioned radiation image detector.

Next, the actions of recording and readout of a radiographic image by the radiation image detector 500 will be described.

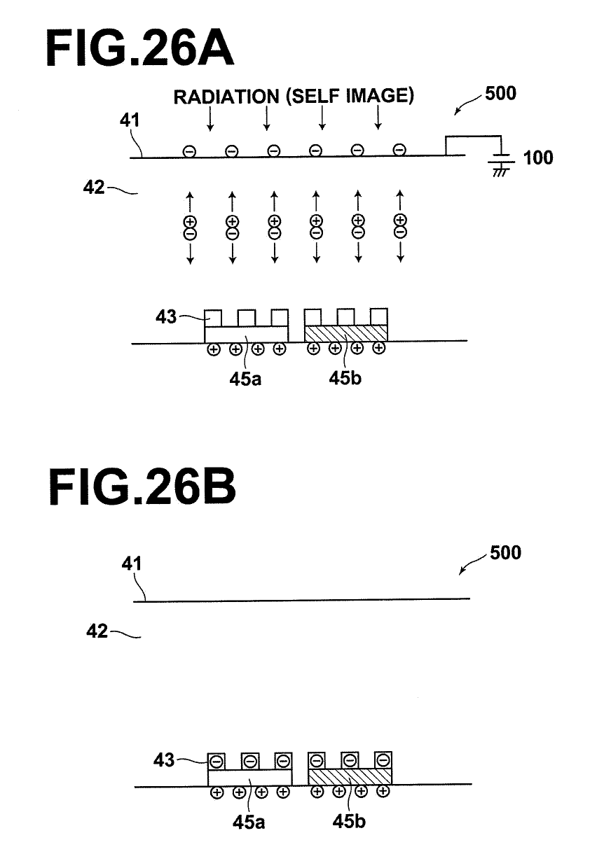

First, as illustrated in FIG. 26A, negative voltage is applied to the first electrode layer 41 of the radiation image detector 500 by a high voltage source 100. While the negative voltage is applied, radiation carrying a self image of the first grating 2 irradiates the radiation image detector 500 from the first electrode layer 41 side.

Further, radiation that has irradiated the radiation image detector 500 passes through the first electrode layer 41, and irradiates the photoconductive layer 42 for recording. A pair of charges is generated in the photoconductive layer 42 for recording by irradiation with the radiation. A positive charge of the charge pair is combined with a negative charge in the first electrode layer 41, and disappears. A negative charge of the charge pair is stored in the charge storage layer 43 as a latent image charge (please refer to FIG. 26B). Since the linear charge storage layer 43 in contact with the second electrode layer 45 is an insulating layer, charges that have reached the charge storage layer 43 are trapped there. The charges are stored and remain there, and do not reach the second electrode layer 45.

Here, in a manner similar to the radiation image detector 400 as described above, among charges generated in the photoconductive layer 42 for recording, only charges with the linear charge storage layer 43 present just under the charges are stored in the charge storage layer 43. Therefore, the intensity of the self image of the first grating 2 is modulated by overlapping with the linear pattern of the charge storage layer 43. Further, image signals of a fringe image reflecting a distortion of the wavefront of a self image by subject m to be examined are stored in the charge storage layer 43.

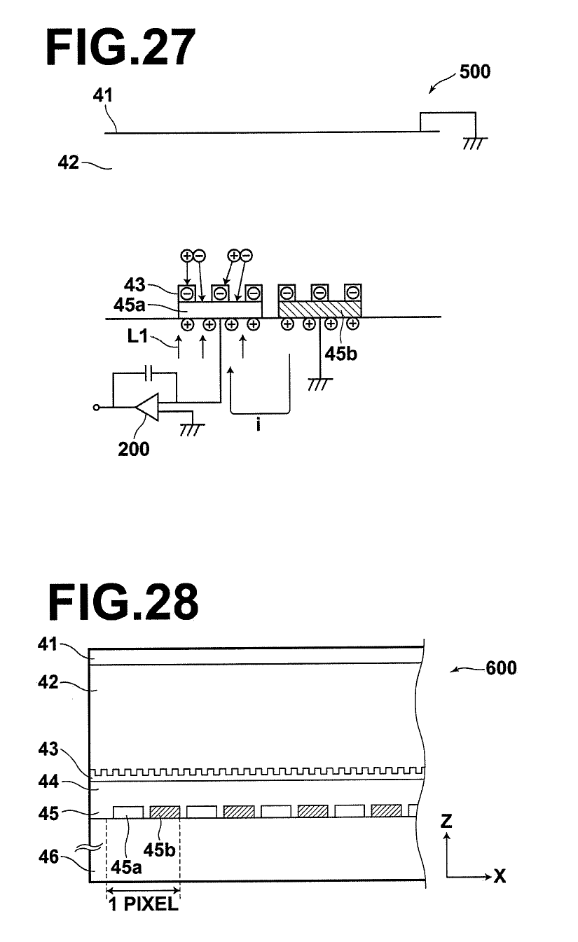

Further, as illustrated in FIG. 27, while the first electrode layer 41 is earthed, linear readout light L1 output from the linear readout light source 700 illuminates the radiation image detector 500 from the second electrode layer 45 side. The readout light L1 passes through the transparent linear electrodes 45a, and illuminates the photoconductive layer 42 for recording in the vicinity of the charge storage layer 43. Positive charges generated by illumination with the readout light L1 are attracted by the linear charge storage layer 43, and recombined with negative charges. Further, negative charges generated by illumination with the readout light L1 are attracted by the transparent linear electrodes 45a, and combined with positive charges in the transparent linear electrodes 45a, and positive charges in the light-blocking linear electrodes 45b through the charge amplifier 200 connected to the transparent linear electrodes 45a. Accordingly, an electric current flows to the charge amplifier 200. The electric current is integrated, and detected as image signals.

In the aforementioned radiation image detectors 400 and 500, the charge storage layer 43 is completely separated in linear form. However, it is not necessary that the charge storage layer 43 is formed in such a manner. For example, as in a radiation image detector 600 illustrated in FIG. 28, a linear pattern may be formed on a flat plate shape to form a grid-shape charge storage layer 43.

In a modified example of the aforementioned embodiment, the first grating 2 is arranged in such a manner to incline with respect to the second grating 3 so that plural fringe images are obtainable by performing one radiography operation. In a similar manner, the first grating 2 may be arranged in such a manner to incline with respect to the linear charge storage layer 43 in the radiation image detectors 400, 500.

In the aforementioned embodiment, a case in which the radiation phase image radiographic apparatus of the present invention is applied to a mammography and display system has been described. However, it is not necessary that the radiation phase image radiographic apparatus of the present invention is applied to the mammography and display system. The radiography phase image radiographic apparatus of the present invention may be applied to a radiation image radiography system for performing radiography on a subject (patient) in standing position, a radiation image radiography system for performing radiography on a subject in decubitus position, a radiation image radiography system that can perform radiography on a subject both in standing position and in decubitus position, a radiography system for performing so-called long-size radiography, and the like.

Further, the present invention may be applied to a radiation phase CT (computed tomography) apparatus for obtaining a three-dimensional image, a stereoradigraphy apparatus for obtaining a stereo image that can provide stereoscopic view, and the like.

In the aforementioned embodiment, a phase contrast image is obtained, and an image that has been conventionally difficult to be rendered can be obtained. However, since conventional X-ray diagnostic imaging is based on absorption images, it is helpful in image reading to refer to an absorption image corresponding a phase contrast image. For example, it is effective to use information represented by a phase contrast image to supplement information that could not be represented by an absorption image. The information represented by the phase contrast image may be used by superimposing or placing the absorption image and the phase contrast image one on the other by using appropriate processing, such as weighting, gradation and frequency processing.

However, if a phase contrast image and an absorption image are obtained in different radiography operations, it becomes difficult to place the phase contrast image and the absorption image one on the other in an excellent manner because a patient's body may move between the two radiography operations. Further, since the number of times of radiography increase, a burden on the patient increases. Further, in recent years, small-angle scattering images have drawn attention besides the phase contrast image and the absorption image. The small-angle scattering image can represent tissue conditions attributable to a fine structure (ultrastructure) in a tissue to be examined. The small-angle scattering image is a prospective new representation method for image diagnosis, for example, in cancers and circulatory diseases.

Therefore, an absorption image generation unit for generating an absorption image from plural fringe images obtained to generate the phase contrast image may be provided in the computer 30. Further, a small-angle scattering image generation unit for generating a small-angle scattering image from plural fringe images obtained to generate the phase contrast image may be provided in the computer 30.

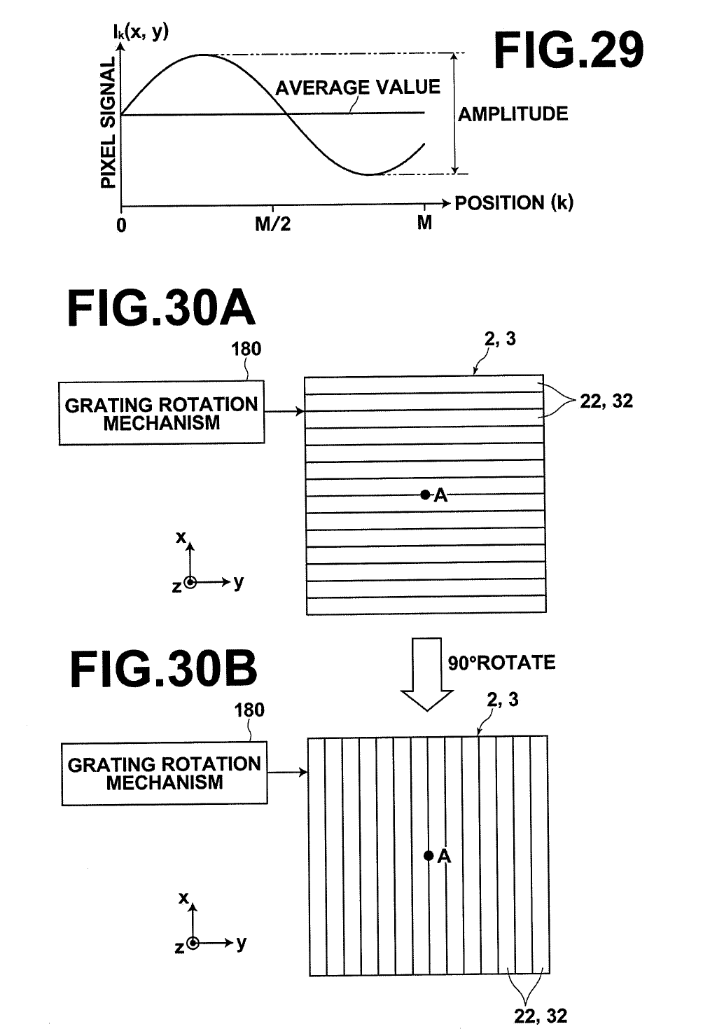

The absorption image generation unit calculates an average value by averaging, with respect to k, pixel signal Ik(x,y) obtainable for each pixel, as illustrated in FIG. 29, and forms an image. Accordingly, an absorption image is generated. Calculation of the average value may be performed by simply averaging pixel signal Ik(x,y) with respect to k. However, when the value of M is small, an error (difference) becomes large. Therefore, after fitting is performed on the pixel signal Ik(x,y) by a sinusoidal wave, an average value of the sinusoidal wave after fitting may be obtained. Further, it is not necessary to use the sinusoidal wave, and a square wave or a triangle wave may be used.

In generation of the absorption image, it is not necessary to use the average value. An addition value obtained by adding pixel signal Ik(x,y) with respect to k, or the like may be used as long as the value corresponds to the average value.

The small-angle scattering image generation unit calculates an amplitude value of pixel signal Ik(x,y) obtainable for each pixel, and forms an image. Accordingly, a small-angle scattering image is generated. Calculation of the amplitude value may be performed by obtaining a difference between the maximum value and the minimum value of the pixel signal Ik(x,y). However, when the value of M is small, an error (difference) becomes large. Therefore, after fitting is performed on the pixel signal Ik(x,y) by a sinusoidal wave, an amplitude value of the sinusoidal wave after fitting may be obtained. Further, it is not necessary to use the amplitude value to generate the small-angle scattering image, and a variance, a standard deviation or the like may be used as a value corresponding to dispersion with respect to an average value.

Further, a phase contrast image is based on a refraction component of X-rays in a periodic arrangement direction (X direction) of the members 22 of the first grating 2 and the members 32 of the second grating 3. Therefore, a refraction component of X-rays in a direction (Y direction) in which the members 22, 23 extend is not reflected in the phase contrast image. Specifically, the outline of a region along a direction (Y direction if the direction crosses X direction at right angles) crossing X direction is rendered, as a phase contrast image based on the refraction component in X direction, through a grating plane, which is XY plane. Therefore, the outline of the region along X direction, which does not cross X direction, is not rendered as the phase contrast image in X direction. Specifically, some region is not rendered depending on the shape or direction of the region, which is subject H to be examined. For example, when the direction of a weight-bearing plane of an articular cartilage, such as a knee, is set to Y direction of XY directions, which are in-plane directions of a grating, rendering of the outline of a region in the vicinity of a weight-bearing plane (YZ plane) substantially along Y direction is supposed to be sufficient. However, rendering of tissues (a tendon, a ligament or the like) in the vicinity of cartilage, and the tissues crossing the weight-bearing plane and extending substantially along X direction, is supposed to be insufficient. If rendering is insufficient, the subject H to be examined may be moved, and radiography may be performed again on the region which has been insufficiently rendered. However, if radiography is performed again, a burden on the subject H to be examined and the work of the radiographer increase. Further, it is difficult to secure a position regeneration characteristic between the previous image and the image obtained by performing radiography again.

Therefore, as another example, a rotation mechanism 180 may be provided in the grid unit 16, as illustrated in FIGS. 30A, 30B. An imaginary line (optical axis A of X-rays) that is orthogonal to the grid planes of the first and second gratings 2, 3 and passes the centers of the grid planes may be used as a center of rotation, and the first grating 2 and the second grating 3 may be rotated, by an arbitrary angle, from a first direction illustrated in FIG. 30A to a second direction illustrated in FIG. 30B. Further, a phase contrast image may be generated in each of the first direction and the second direction. Such structure is advantageous.

When the apparatus is structured in such a manner, it is possible to solve the aforementioned problem in the position regeneration characteristic. FIG. 30A illustrates the first direction of the first grating 2 and the second grating 3 in which the members 32 of the second grating 3 extend along Y direction. FIG. 30B illustrates the second direction of the first grating 2 and the second grating 3 in which the members 32 of the second grating 3 extend along X direction by rotating the first grating 2 and the second grating 3, by 90 degrees, from the state illustrated in FIG. 30A. However, the rotation angle of the first grating 2 and the second grating 3 may be an arbitrary angle as long as the inclination relationship between the first grating 2 and the second grating 3 is maintained. Further, rotation operations may be performed twice or more to change the direction to a third direction, a fourth direction and the like in addition to the first direction and the second direction. Further, a phase contrast image may be generated at each direction.

In the above descriptions, the first grating 2 and the second grating 3, which are one-dimensional gratings, are rotated. Instead, the first grating 2 and the second grating 3 may be structured as two-dimensional gratings composed of two-dimensionally-arranged extending members 22, 32, respectively.

When the apparatus is structured in such a manner, it is possible to obtain a phase contrast image for the first direction and the second direction by performing one radiography operation. Therefore, there is no influence of the body movement of the subject between radiography operations and vibration of the apparatus, compared with the structure in which the one-dimensional gratings are rotated. Therefore, a more excellent position regeneration characteristic between the phase contrast image for the first direction and the phase contrast image for the second direction is achievable. Further, since a rotation mechanism is not used, it is possible to simplify the apparatus and to reduce the cost for production.

What is claimed is:

1. A radiation phase image obtainment method for obtaining a phase contrast image of a subject by using a radiation phase image radiographic apparatus,
wherein the radiation phase image radiographic apparatus includes a first grating in which a grating structure is periodically arranged, and that forms a first periodic pattern image by passing radiation output from a radiation source, and a second grating in which a grating structure having a part that transmits the first periodic pattern image formed by the first grating and a part that blocks the first periodic pattern image is periodically arranged, and that forms a second periodic pattern image, and a radiation image detector that detects the second periodic pattern image formed by the second grating, and
wherein the radiation phase image radiographic apparatus performs magnification radiography by moving the radiation image detector relative to a subject in a direction away from the subject,
the method comprising the steps of:
receiving an input of a magnification ratio in the magnification radiography;
obtaining calibration data corresponding to the received magnification ratio, and which are based on the second periodic pattern image detected by the radiation image detector without placing the subject; and
obtaining the phase contrast image based on the obtained calibration data and the second periodic pattern image detected by the radiation image detector with the subject placed.

2. A radiation phase image radiographic apparatus comprising:
a first grating in which a grating structure is periodically arranged, and that forms a first periodic pattern image by passing radiation output from a radiation source;
a second grating in which a grating structure having a part that transmits the first periodic pattern image formed by the first grating and a part that blocks the first periodic pattern image is periodically arranged, and that forms a second periodic pattern image;
a radiation image detector that detects the second periodic pattern image formed by the second grating;
a magnification ratio obtainment unit that receives an input of a magnification ratio in magnification radiography to obtain the magnification ratio;
a movement mechanism that moves, based on the magnification ratio obtained by the magnification ratio obtainment unit, the radiation image detector relative to a subject in a direction away from the subject;
a calibration data obtainment unit that obtains calibration data corresponding to the magnification ratio obtained by the magnification ratio obtainment unit, and which are based on the second periodic pattern image detected by the radiation image detector without placing the subject; and
a phase contrast image generation unit that generates a phase contrast image based on the calibration data obtained by the calibration data obtainment unit and the second periodic pattern image detected by the radiation image detector with the subject placed.

3. A radiation phase image radiographic apparatus, as defined in claim 2, wherein calibration data corresponding to a plurality of magnification ratios are set in advance in the calibration data obtainment unit.

4. A radiation phase image radiographic apparatus, as defined in claim 2, wherein the calibration data obtainment unit obtains the calibration data corresponding to the magnification ratio after the movement mechanism has moved the radiation image detector by a distance corresponding to the magnification ratio.

5. A radiation phase image radiographic apparatus, as defined in claim 2, the apparatus further comprising:
a displacement detection unit that detects a displacement in the position of the first grating or the second grating,
wherein the calibration data obtainment unit obtains the calibration data when the displacement detection unit has detected a displacement in the position of the first grating or the second grating.

6. A radiation phase image radiographic apparatus, as defined in claim 2, wherein the calibration data have been corrected by using sensitivity correction data about the radiation image detector corresponding to the magnification ratio obtained by the magnification ratio obtainment unit.

7. A radiation phase image radiographic apparatus, as defined in claim 2, wherein the calibration data have been corrected by using offset correction data about the radiation image detector.

8. A radiation phase image radiographic apparatus, as defined in claim 2, the apparatus further comprising:
a scan mechanism that moves at least one of the first grating and the second grating in a direction orthogonal to a direction in which the at least one of the first grating and the second grating extends,
wherein the phase contrast image generation unit generates the phase contrast image based on a plurality of second periodic pattern images detected by the radiation image detector with respect to respective positions of the at least one of the first grating and the second grating with movement by the scan mechanism.

9. A radiation phase image radiographic apparatus, as defined in claim 2, wherein the first grating and the second grating are arranged in such a manner that a direction in which the first grating extends and a direction in which the second grating extends incline relative to each other, and
wherein the phase contrast image generation unit generates the phase contrast image by using radiographic image signals detected by the radiation image detector by irradiating the subject with the radiation only once.

10. A radiation phase image radiographic apparatus, as defined in claim 9, wherein the phase contrast image generation unit obtains, based on the radiographic image signals detected by the radiation image detector, radiographic image signals read out from groups of pixel rows, and the groups being different from each other, as radiographic image signals representing a plurality of fringe images different from each other, and generates the phase contrast image based on the obtained radiographic image signals representing the plurality of fringe images.
